(19) United States
(12) Patent Application Publication
(10) Pub. No.: US 2023/0086501 A1
(43) Pub. Date: Mar. 23, 2023

(54) METHOD OF TREATMENT USING SYNERGISTIC DIETARY SUPPLEMENTS TO RELIEVE MOOD FLUCTUATIONS, SKIN BLEMISHES, REDUCED ENERGY LEVELS, AND/OR DIETARY CRAVINGS LINKED TO HORMONAL FLUCTUATIONS OR THE MENSTRUAL CYCLE

(71) Applicant: Semaine Health, Atlanta, GA (US)

(72) Inventor: Matthew M. Crane, Atlanta, GA (US)

(21) Appl. No.: 17/946,237

(22) Filed: Sep. 16, 2022

Related U.S. Application Data
(60) Provisional application No. 63/246,402, filed on Sep. 21, 2021.

(51) Int. Cl. A23L 33/105; A23L 33/15; A23L 33/16; A23L 33/24

(52) U.S. Cl. CPC A23L 33/105; A23L 33/15; A23L 33/16; A23L 33/24

(57) ABSTRACT

Methods of treating mood fluctuations, skin blemishes, low energy levels, and/or dietary cravings associated with hormonal fluctuations and/or menstruation are provided. Hormonal imbalance treatment systems are further provided.

### CROSS-REFERENCE TO RELATED APPLICATIONS

This application claims the benefit of U.S. Patent Application Ser. No. 63/246,402, filed Sep. 21, 2021, the entirety of which is incorporated herein by reference for all purposes.

### FIELD OF THE INVENTION

The present invention relates to a method of treating changes in mood, skin, energy, or food cravings related to hormone fluctuations through the use of a dietary supplement. A further method treats mood fluctuations, skin blemishes, low energy levels, and/or dietary cravings that are linked to changes in hormone levels linked to specific times of the menstrual cycle or as a result of changes in the menstrual cycle due to aging, through the synergistic use of multiple dietary supplements.

### BACKGROUND

Nutritional supplements for women that address mood or skin changes linked to the menstrual cycle are predominantly focused on dietary supplements that may affect levels of the dominant sex hormones estrogen or progesterone through the use of plant extracts that may bind to the estrogen receptors. However, this focus on sex hormones fails to address many underlying metabolic changes. Although sex hormone changes are the most widely known changes during perimenopause and menopause, metabolic hormones may vary during this time, and metabolic hormone changes are often neglected in currently available dietary supplements.

Metabolic hormones, such as leptin and insulin, fluctuate throughout the menstrual cycle and, as a result of the cessation of the menstrual cycle, through perimenopause and menopause. Particularly as a result of dietary and activity changes in modern society, changes in metabolic hormones or sensitivity may drive many symptoms.

Accordingly, there exists a need for a method of treatment having multiple targets that results in improved mood, skin, and energy levels or cravings through an improvement in metabolic parameters. If there was an effective method for alleviating skin breakouts, mood changes, energy levels, and/or dietary cravings without focusing on directly influencing sex hormone levels, this would provide significant relief of symptoms for recipients, and would constitute a useful contribution to the art.

### SUMMARY

In an example, the present disclosure provides a method of treating fluctuations, skin blemishes, low energy levels, and/or dietary cravings associated with hormonal fluctuations and/or menstruation in a female human, including: administering to the female human a dietary supplement formulation including three or more components including a total combined daily dose of: from about 30 milligrams to about 400 milligrams of berberine; from about 50 milligrams to about 400 milligrams of grape seed extract; and from about 10 milligrams to about 200 milligrams of passionflower extract. The dietary supplement formulation is administered daily for at least four weeks. The three or more components act synergistically to treat mood fluctuations, skin blemishes, low energy levels, and/or dietary cravings. In certain examples, the dietary supplement formulation may further include a total combined daily dose of one or more components selected from: from about 1 milligram to about 100 milligrams of magnesium; from about 1 milligram to about 60 milligrams of zinc; from about 1 milligram to about 30 milligrams of vitamin B1; from about 1 milligram to about 30 milligrams of vitamin B6; from about 150 micrograms to about 900 micrograms of dietary folate equivalents (“DFE”) of vitamin B9; and/or from about 0.5 micrograms to about 10 micrograms of vitamin B12. In other examples, the dietary supplement formulation may further include psyllium and/or methylcellulose. In still other examples, the dietary supplement formulation may include: from about 40 milligrams to about 140 milligrams of berberine; from about 90 milligrams to about 280 milligrams of grape seed extract; and from about 70 milligrams to about 140 milligrams of passionflower extract. In still other examples, the dietary supplement formulation may include from about 70 milligrams to about 90 milligrams of berberine; from about 170 milligrams to about 190 milligrams of grape seed extract; and from about 70 milligrams to about 90 milligrams of passionflower extract. In still other examples, the dietary supplement formulation may include from about 5 milligrams to about 40 milligrams of magnesium; from about 2 milligrams to about 30 milligrams of zinc; from about 2 milligrams to about 25 milligrams of vitamin B1; from about 2 milligrams to about 25 milligrams of vitamin B6; from about 300 micrograms to about 800 micrograms of DFE of vitamin B9; and/or from about 2 micrograms to about 8 micrograms of vitamin B12.

In another example, the present disclosure provides a method of improving level(s) of one or more blood biomarkers associated with metabolic hormones and/or inflammation levels in a female human, including: administering to the female human a dietary supplement formulation including three or more components including a total combined daily dose of: from about 30 milligrams to about 400 milligrams of berberine; from about 50 milligrams to about 400 milligrams of grape seed extract; and from about 10 milligrams to about 200 milligrams of passionflower extract. The dietary supplement formulation is administered daily for at least four weeks. The three or more components act synergistically to improve level(s) of one or more blood biomarkers. The one or more blood biomarkers are selected from the group consisting of HbA1c, LDL cholesterol, and CRP. In certain examples, the dietary supplement formulation may further include a total combined daily dose of one or more components selected from: from about 1 milligram to about 100 milligrams of magnesium; from about 1 milligram to about 60 milligrams of zinc; from about 1 milligram to about 30 milligrams of vitamin B1; from about 1 milligrams to about 30 milligrams of vitamin B6; from about 150 micrograms to about 900 micrograms of DFE of vitamin B9; and/or from about 0.5 micrograms to about 10 micrograms of vitamin B12. In other examples, the dietary supplement formulation may further include psyllium and/or methylcellulose. In still other examples, the dietary supplement formulation may include: from about 40 milligrams to about 140 milligrams of berberine; from about 90 milligrams to about 280 milligrams of grape seed extract; and from about 30 milligrams to about 140 milligrams of passionflower extract. In still other examples, the dietary supplement formulation may include: from about 70 milligrams to about 90 milligrams of berberine; from about 170 milligrams to about 190 milligrams of grape seed extract; and from about 70 milligrams to about 90 milligrams of passionflower extract. In still other examples, the dietary supplement formulation may include: from about 5 milligrams to about 40 milligrams of magnesium; from about 2 milligrams to about 30 milligrams of zinc; from about 2 milligrams to about 25 milligrams of vitamin B1; from about 2 milligrams to about 25 milligrams of vitamin B6; from about 300 micrograms to about 800 micrograms of DFE of vitamin B9; and/or from about 2 micrograms to about 8 micrograms of vitamin B12.

In yet another example, the present disclosure provides a hormonal imbalance treatment system, including: a single dosage form mixture of three or more components including: from about 30 milligrams to about 400 milligrams of berberine that has been standardized, or complexed or encapsulated with phospholipids; from about 50 milligrams to about 400 milligrams of grape seed extract that has been standardized, or complexed or encapsulated with phospholipids; and from about 10 milligrams to about 200 milligrams of passionflower extract that has been standardized, or complexed or encapsulated with phospholipids. Synergistic activity of the mixture when administered daily for at least four weeks to a human population causes on average in a female human: a decrease in mood fluctuations; a decrease in skin blemishes; an improvement in low energy levels; a reduction in dietary cravings; and/or an improvement in level(s) of one or more blood biomarkers selected from the group consisting of HbA1c, LDL cholesterol, and CRP. In certain examples, the mixture may further include: from about 5 milligrams to about 40 milligrams of magnesium; from about 2 milligrams to about 30 milligrams of zinc; from about 2 milligrams to about 25 milligrams of vitamin B1; from about 2 milligrams to about 25 milligrams of vitamin B6; from about 300 micrograms to about 800 micrograms of DFE of vitamin B9; and/or from about 2 micrograms to about 8 micrograms of vitamin B12.

In yet another example, the present disclosure provides a method of treating mood fluctuations, skin blemishes, low energy levels, and/or dietary cravings associated with hormonal fluctuations and/or menstruation in a human, including: administering to the human a dietary supplement formulation including a mixture of berberine, grape seed extract, and passionflower extract. The dietary supplement formulation is administered daily for at least four weeks. The three or more components act synergistically to treat mood fluctuations, skin blemishes, low energy levels, and/or dietary cravings. In certain examples, the dietary supplement formulation may include a mixture of a total combined daily dose of: from about 30 milligrams to about 400 milligrams of berberine; from about 50 milligrams to about 400 milligrams of grape seed extract; and from about 10 milligrams to about 200 milligrams of passionflower extract. In other examples, the dietary supplement formulation may further include a total combined daily dose of one or more components selected from: from about 1 milligram to about 100 milligrams of magnesium; from about 1 milligram to about 60 milligrams of zinc; from about 1 milligram to about 30 milligrams of vitamin B1; from about 1 milligram to about 30 milligrams of vitamin B6; from about 150 micrograms to about 900 micrograms of dietary folate equivalents (DFE) of vitamin B9; and/or from about 0.5 micrograms to about 10 micrograms of vitamin B12. In still other examples, the dietary supplement formulation may further include psyllium and/or methylcellulose. In still other examples, the dietary supplement formulation may include a mixture of a total combined daily dose of: from about 40 milligrams to about 140 milligrams of berberine; from about 90 milligrams to about 280 milligrams of grape seed extract; and from about 30 milligrams to about 140 milligrams of passionflower extract. In still other examples, the dietary supplement formulation may include a mixture of a total combined daily dose of: from about 70 milligrams to about 90 milligrams of berberine; from about 170 milligrams to about 190 milligrams of grape seed extract; and from about 70 milligrams to about 90 milligrams of passionflower extract. In still other examples, the dietary supplement formulation may further include: from about 5 milligrams to about 40 milligrams of magnesium; from about 2 milligrams to about 30 milligrams of zinc; from about 2 milligrams to about 25 milligrams of vitamin B1; from about 2 milligrams to about 25 milligrams of vitamin B6; from about 300 micrograms to about 800 micrograms of DFE of vitamin B9; and/or from about 2 micrograms to about 8 micrograms of vitamin B12.

### DETAILED DESCRIPTION

The following description is merely exemplary in nature and is not intended to limit the present disclosure, application, or uses.

In one example, a method of treating changes in mood, skin quality, energy levels, and/or dietary cravings associated with hormonal fluctuations and/or the menstrual cycle includes administering a synergistic dietary supplement formulation to address metabolic hormones and parameters. The administering may be performed regularly (i.e., performed daily or on most days).

In describing elements of the present disclosure, the terms “1^{st},” “2^{nd},” “first,” “second,” “A,” “B,” “(a),” “(b),” and the like may be used herein. These terms are only used to distinguish one element from another element, but do not limit the corresponding elements irrespective of the nature or order of the corresponding elements.

Numerical values, including endpoints of ranges, may be expressed herein as approximations preceded by the term “about,” “approximately,” or the like. In such cases, other examples include the particular numerical values. Regardless of whether a numerical value is expressed as an approximation, two examples are included in this disclosure: one expressed as an approximation, and another not expressed as an approximation. It will be further understood that an endpoint of each range is significant both in relation to another endpoint, and independently of another endpoint.

Where a range of values is provided, the range is intended to mean that each intervening integer value between the upper and lower limit of that range and any other stated or intervening value in that stated range is encompassed within the disclosure. For example, if a range of 10 mg to 20 mg is stated, it is intended that 11 mg, 12 mg, 13 mg, 14 mg, 15 mg, 16 mg, 17 mg, 18 mg, and 19 mg are also explicitly disclosed, as well as the range of values greater than or equal to 10 mg and the range of values less than or equal to 20 mg.

The use of the terms “a,” “an,” “the,” and similar referents in the context of describing the present disclosure (especially in the context of the claims) is to be construed to cover both the singular and the plural, unless otherwise indicated herein or clearly contradicted by context. Unless otherwise indicated or the context suggests otherwise, as used herein, “a” or “an” means “at least one” or “one or more.” Recitation of ranges of values herein are merely intended to serve as a shorthand method of referring individually to each separate value falling within the range, unless otherwise indicated herein, and each separate value is incorporated into the specification as if it were individually recited herein.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group including A, B, . . . and N. In other words, the phrases mean any combination of one or more of the elements A, B, . . . or N including any one element alone or the one element in combination with one or more of the other elements which may also include, in combination, additional elements not listed.

All methods described herein may be performed in any suitable order unless otherwise indicated herein or otherwise clearly contradicted by context. The use of any and all examples, or exemplary language (for example, “such as”) provided herein, is intended merely to better illuminate the invention and does not pose a limitation on the scope of the invention unless otherwise claimed. No language in the specification should be construed as indicating any non-claimed element as essential to the practice of the invention.

As used herein, the terms “comprise(s),” “include(s),” “having,” “has,” “can,” “contain(s),” and variants thereof, are intended to be open-ended transitional phrases, terms, or words that do not preclude the possibility of additional acts, structures, elements, or components. The present description also contemplates other examples “comprising,” “consisting of,” and “consisting essentially of,” the examples or elements presented herein, whether explicitly set forth or not.

As used herein, the term “about,” when used in the context of a numerical value or range set forth, is intended to describe values either above or below the stated value in a range of approximately ±15%; in other examples, the values may range in value either above or below the stated value in a range of approximately ±10%; in other examples, the values may range in value either above or below the stated value in a range of approximately ±5%; in other examples, the values may range in value either above or below the stated value in a range of approximately ±2%; in other examples, the values may range in value either above or below the stated value in a range of approximately ±1%. The preceding ranges are intended to be made clear by context, and no further limitation is implied.

The terms “synergy,” “synergic,” “synergistic,” and “synergistically,” as used herein, unless stated otherwise, alone or in combination with other terms, refer to an interaction between two or more active ingredients that causes the total effect of the two or more active ingredients to be greater than the sum of the additive individual effects of each individual active ingredient.

The terms “treatment,” “treat,” and “treating,” as used herein, unless stated otherwise, alone or in combination with other terms, refer to any treatment of a disease or disorder, in a mammal, including: arresting or suppressing the development of clinical symptoms; and/or causing the regression of clinical symptoms.

“Nutraceutically acceptable carrier,” as used herein, unless stated otherwise, alone or in combination with other terms, refers any carrier, diluent, or excipient that is compatible with the other ingredients of the formulation and not deleterious to the user.

Delivery or Treatment System

The formulations are preferably in unit dosage forms, or unit nutritional or dietary supplement forms, namely servings. In such forms, the preparation is subdivided into unit doses or servings containing appropriate quantities of the active ingredient(s). The unit dosage form may be a packaged formulation, the package containing discrete quantities of formulation, such as packaged cooked pieces, tablets, capsules, and powders in vials or ampoules.

Suitable dosage forms for use in the methods and systems of the present disclosure may include, but not be limited to, tablets, capsules, solutions, suspensions, powders, gums, and confectionaries themselves, or an appropriate number of any of these in packaged form. Sublingual systems may include, but are not limited to, dissolvable tabs under and on the tongue, liquid drops, and beverages. Edible films, hydrophilic polymers, oral dissolvable films, or oral dissolvable strips may be used as dosage forms. Other useful delivery systems may include oral or nasal sprays or inhalers, and the like.

For oral administration, individual active ingredients or two or more active ingredients may be combined with one or more solid inactive ingredients for the preparation of tablets, capsules, pills, powders, granules, or other suitable dosage forms. For example, an individual active ingredient or two or more active ingredients may be combined with at least one excipient such as a filler, a binder, a humectant, a disintegrating agent, a solution retarder, an absorption accelerator, a wetting agent, an absorbent, or a lubricating agent. Examples of useful excipients may include magnesium stearate, calcium stearate, mannitol, xylitol, a sweetener, starch, carboxymethylcellulose, microcrystalline cellulose, silica, gelatin, silicon dioxide, combinations thereof, and the like. Examples of carrier materials may include starch, gelatin, acacia, microcrystalline cellulose, kaolin, dicalcium phosphate, calcium carbonate, sodium chloride, alginic acid, and the like. Examples of binders may include methylcellulose, sodium carboxymethylcellulose, polyvinylpyrrolidone, hydroxypropyl methylcellulose, ethyl cellulose, and the like. Examples of lubricants or flow agents may include magnesium stearate, calcium stearate, stearic acid, silicone fluid, talc, waxes, oils, colloidal silica, and the like. The usefulness of such excipients is well known in the art.

Nutraceutical formulations are contemplated and may be administered in combination with a nutraceutically acceptable carrier. The active ingredients in such formulations may include from 1% by weight to 99% by weight, or alternatively, 0.1% by weight to 99.9% by weight.

Liquid nutritional formulations for oral administration may be prepared in water, juices, or other aqueous vehicles. In addition to the above enumerated ingredients or compound, liquid nutritional compositions may include suspending agents. Examples of suspending agents may include alginates, tragacanth, pectin, kelgin, carrageenan, polyvinyl alcohol, and the like. The liquid nutritional formulations may be in the form of a solution, an emulsion, a syrup, a gel, or an elixir that may include, together with the above-enumerated ingredients or compounds, a wetting agent, a sweetener, and/or a coloring and/or a flavoring agent. Various liquid and powder nutritional formulations may be prepared by conventional methods.

In an example, a hormonal imbalance treatment system of the present disclosure includes: a single dosage form mixture of three or more components including: from about 30 milligrams to about 400 milligrams of berberine that has been standardized, and complexed or encapsulated with phospholipids; from about 50 milligrams to about 400 milligrams of grape seed extract that has been standardized, or complexed or encapsulated with phospholipids; and from about 10 milligrams to about 200 milligrams of passionflower extract that has been standardized, or complexed or encapsulated with phospholipids; and wherein synergistic activity of the mixture when administered daily for at least four weeks to a human population causes on average in a female human: a decrease in mood fluctuations; a decrease in skin blemishes; an improvement in low energy levels; a reduction in dietary cravings; and/or an improvement in level(s) of one or more blood biomarkers selected from the group consisting of HbA1c, LDL cholesterol, and CRP.

Routes of Administration

The formulations may be administered by any route, including, but not limited to, oral, sublingual, buccal, ocular, pulmonary, rectal, and parenteral administration, or as an oral or nasal spray (e.g., inhalation of nebulized vapors, droplets, or solid particles). Examples of parenteral administration may include, but not be limited to, intravenous, intramuscular, intraarterial, intraperitoneal, intranasal, intravaginal, intravesical (e.g., to the bladder), intradermal, transdermal, topical, and subcutaneous administration.

In examples of the present disclosure, treatment methods may be performed for as long a period as necessary, either in a single, uninterrupted session, or in discrete sessions. According to examples of the present disclosure, a treatment schedule may include a duration of from about four to about sixteen weeks, or from about 5 to about 16 weeks, from about 6 to about 16 weeks, from about 7 to about 16 weeks, from about 8 to about 16 weeks, from about 9 to about 16 weeks, from about 10 to about 16 weeks, from about 11 to about 16 weeks, from about 12 to about 16 weeks, from about 13 to about 16 weeks, from about 14 to about 16 weeks, from about 15 to about 16 weeks, from about 4 to about 15 weeks, from about 4 to about 14 weeks, from about 4 to about 13 weeks from about 4 to about 12 weeks, from about 4 to about 11 weeks, from about 4 to about 10 weeks, form about 4 to about 9 weeks, from about 4 to about 8 weeks, from about 4 to about 7 weeks, from about 4 to about 6 weeks, from about 4 to about 5 weeks, from about 5 to about 15 weeks, from about 5 to about 14 weeks, from about 5 to about 13 weeks, from about 5 to about 12 weeks, from about 5 to about 11 weeks, from about 5 to about 10 weeks, from about 5 to about 9 weeks, from about 5 to about 8 weeks, from about 5 to about 7 weeks, from about 5 to about 6 weeks, from about 6 to about 15 weeks, from about 6 to about 14 weeks, from about 6 to about 13 weeks, from about 6 to about 12 weeks, from about 6 to about 11 weeks, from about 6 to about 10 weeks, from about 6 to about 9 weeks, from about 6 to about 8 weeks, from about 6 to about 7 weeks, from about 7 to about 15 weeks, from about 7 to about 14 weeks, from about 7 to about 13 weeks, from about 7 to about 12 weeks, from about 7 to about 11 weeks, from about 7 to about 10 weeks, form about 7 to about 9 weeks, from about 7 to about 8 weeks, from about 8 to about 15 weeks, from about 8 to about 14 weeks, from about 8 to about 13 weeks, from about 8 to about 12 weeks, from about 8 to about 11 weeks, from about 8 to about 10 weeks, from about 8 to about 9 weeks, from about 9 to about 15 weeks, from about 9 to about 14 weeks, from about 9 to about 13 weeks, from about 9 to about 12 weeks, from about 9 to about 11 weeks, from about 9 to about 10 weeks, from about 10 to about 15 weeks, from about 10 to about 14 weeks, from about 10 to about 13 weeks, from about 10 to about 12 weeks, from about 10 to about 11 weeks, from about 11 to about 15 weeks, from about 11 to about 14 weeks, from about 11 to about 13 weeks, from about 11 to about 12 weeks, from about 12 to about 15 weeks, from about 12 to about 14 weeks, from about 12 to about 13 weeks, from about 13 to about 15 weeks, from about 13 to about 14 weeks, or from about 14 to about 15 weeks. According to another example, a treatment schedule may be repeated as required.

A course of administration according to the treatment methods of the present disclosure may be simple, and straightforward. A formulation of the present disclosure may be administered once a day, or subdivided and administered at multiple times during a day.

Hormonal Fluctuations Linked to Menstruation

The menstrual cycle is a process characterized by changes in hormone levels, and specifically, fluctuating levels of estrogen and progesterone. As both estrogen and progesterone levels decrease in the days following ovulation, the menstrual cycle transitions from the luteal phase to the follicular phase, and eventually transitions to menstruation. The menstrual cycle transitions are accompanied by changes in levels of metabolic hormones, including changes in levels of insulin and leptin. Symptoms of changes in mood, including, but not limited to, irritability, anxiety, and/or depression, are common, following ovulation and in the lead up to menstruation. Symptoms of changes in mood may decrease with the onset of menstruation, or may persist throughout menstruation.

As a human ages, the menstrual cycle may change, and a reduction in levels of sex hormones may lead into a period of slowing or sporadic menstrual cycles (referred to as “perimenopause”) prior to the complete stop of menstruation (referred to as “menopause”). The changes in levels of sex hormones during perimenopause are frequently accompanied by symptoms that may include acne or skin breakouts, mood changes, food cravings, and changes in energy levels. Alteration in metabolic hormones may also occur during perimenopause, and during perimenopause a human may commonly experience increased insulin resistance. Humans experiencing insulin resistance during perimenopause may also be more likely to experience changes in mood, skin, and energy, in addition to weight gain and an increased risk of cardiovascular disease. Without being bound by theory, addressing insulin resistance or metabolic dysregulation and altered lipid profiles may promote healthy aging and heart health.

Standard pharmacological interventions for mood fluctuations or skin breakouts that may result from changes in hormonal levels linked to the menstrual cycle primarily rely on forms of hormonal contraception, which may provide a subject with consistent levels of hormones.

Hormonal contraception has been found to mitigate mood changes and reduce skin breakouts related to menstruation. Because high doses of progestin may have negative side effects, including, but not limited to, weight gain, and altered blood clotting in individuals with higher risk of strokes, hormonal contraception may include both estrogen and progestin.

For significant mood fluctuations that may be linked to effects of the menstrual cycle, referred to as “premenstrual dysphoric disorder” (“PMDD”), common treatment options may include hormonal contraception, and selective serotonin reuptake inhibitors (“SSRIs”). However, the cause of PMDD is not well understood, and optimal treatment protocols are still in development. Women diagnosed with PMDD may have documented differences in neurotransmitter levels, and pharmacological interventions may typically include compounds demonstrated to affect such neurotransmitter levels.

The standard pharmacological intervention for insulin resistance, especially for women of childbearing age but suffering from infertility linked to poly-cystic ovarian syndrome (“PCOS”), is metformin. Metformin has a good safety profile and may improve insulin sensitivity and reduce anovulatory menstrual cycles.

Insulin resistance may be linked with increased chronic inflammation, increased cardiovascular disease risk, abnormal lipid profiles, weight gain, mood changes, and low energy levels. Insulin resistance has become increasingly common in the western world as a result of changes in diet and physical activity. Changes in metabolic hormone levels may be important to consider when addressing fluctuations in skin quality, mood, energy level, and dietary cravings.

Increased levels of inflammatory markers have also been linked with higher self-reported levels of mood disruption, leading up to and during the menstrual cycle. Similarly, higher inflammatory markers during perimenopause and menopause have been linked with increased mood disruptions.

Higher levels of inflammatory markers have been correlated with higher levels of insulin resistance, and with metabolic disruption. Continuous activation of inflammatory markers may increase insulin resistance by suppressing insulin-signaling pathways. Because fat cells may alter (i.e., increase) the inflammatory state in the surrounding tissues, a negative feedback loop may result in which increased inflammation may result in increased insulin resistance, which in turn may result in increased adiposity. Thus, in addition to influencing metabolic hormones by affecting insulin sensitivity, reducing an inflammatory response may similarly assist in stabilizing metabolic hormones.

Further, there has been research into a connection between nutritional deficiencies and metabolic disruptions. Low levels of dietary magnesium and low levels of dietary zinc have been separately shown to significantly increase the likelihood of insulin resistance and the development of type-2 diabetes.

In the nutraceutical or dietary supplement space, research and product development for treatments for women affected by changes in hormone levels linked to the menstrual cycle has primarily, if not exclusively, focused on approaches that affect sex hormone levels. Several of the most popular and commonly used supplements for menstrual pain may include chasteberry (Vitex agnus-castus), dong quai, black cohosh (Cimicifuga racemose), and maca (Lepidium meyenii). Without being bound by theory, the most popular and commonly used supplements for menstrual pain are designed to influence levels of estrogen and progesterone, and as a result, to modulate period pain or to affect polycystic ovarian syndrome (“PCOS”). Further, these supplements may have potential drawbacks, and the supplements do not indicate that they are necessarily useful for treating metabolic hormone changes. For example, dong quai and black cohosh both have estrogenic activities, and patients with hormone-sensitive cancers (especially estrogen-receptor-positive cancers) have been recommended to avoid dong quai and black cohosh. Maca has also been demonstrated to increase luteinizing hormones (“LHs”) in mouse models, and appears to affect testosterone levels in humans. Chasteberry appears to restore LH levels and increase progesterone levels, and has been clinically shown to reduce menstrual pain. Because chasteberry has phytoestrogen properties, individuals with hormone-sensitive cancers have been recommended to avoid chasteberry.

The focus on influencing sex hormones may also be limiting by limiting the applicable or interested patient population. The widespread adoption of long-term birth control, including intra-uterine devices, periodic injections (such as Deepo-Provera), or implantable birth control (such as Nexplanon), means that the relative levels of sex hormones may vary widely in the population, and may require individualized approaches to treat symptoms related to mood changes, skin quality, energy level, or food cravings.

In the nutraceutical space, individualized approaches have also been leveraged to treat symptoms arising during perimenopause and menopause. Without being bound by theory, the changes in mood, cravings, skin quality, and/or energy levels that may arise during perimenopause are primarily addressed through plant polyphenols that may bind to the estrogen receptors and may thus help offset the decline in estrogen levels during this period. Examples of plant polyphenols may include phytoestrogens including soy isoflavones, such as genistein and pine bark polyphenols. Products have been marketed based on the relative affinity of a photoestrogen for either a or R estrogen receptors. Although phytoestrogens have been shown to help with the changes in mood, energy level, and skin quality that occur during perimenopause, many women may be reluctant to take estrogen or phytoestrogens due to concerns about perceived cancer risk.

Formulations and Methods of the Present Disclosure

In an example of the methods of the present disclosure, a method of treating mood fluctuations, skin blemishes, low energy levels, and/or dietary cravings associated with hormonal fluctuations and/or menstruation in a female human, may include administering to the female human a synergistic dietary supplement formulation daily for several weeks or several months. In certain examples, the administering of the synergistic dietary supplement formulation may stabilize one or more metabolic hormones of the female human.

In another example of the methods of the present disclosure, a method of treating mood fluctuations, skin blemishes, low energy levels, and/or dietary cravings associated with hormonal fluctuations and/or menstruation in a female human may include administering to the female human a synergistic dietary supplement formulation daily for several weeks or several months, the synergistic dietary supplement formulation including three or more active ingredients selected from the group consisting of berberine, grape seed extract, passionflower extract, magnesium, zinc, and one or more B vitamins.

In yet another example of the methods of the present disclosure, a method of treating mood fluctuations, skin blemishes, low energy levels, and/or dietary cravings associated with hormone fluctuations and/or menstruation in a female human, including: administering to the female human a dietary supplement formulation including three or more components including a total combined daily dose of: from about 30 milligrams to about 400 milligrams of berberine; from about 50 milligrams to about 400 milligrams of grape seed extract; and from about 10 milligrams to about 200 milligrams of passionflower extract; wherein the dietary supplement formulation is administered daily for at least four weeks; and wherein the three or more components act synergistically to treat mood fluctuations, skin blemishes, low energy levels, and/or dietary cravings.

In yet another example of the methods of the present disclosure, a method of treating mood fluctuations, skin blemishes, low energy levels, and/or dietary cravings associated with hormonal fluctuations and/or menstruation in a human, including: administering to the human a dietary supplement formulation including a mixture of berberine, grape seed extract, and passionflower extract; wherein the dietary supplement formulation is administered daily for at least four weeks; and wherein the three or more components act synergistically to treat mood fluctuations, skin blemishes, low energy levels, and/or dietary cravings.

In yet another example of the methods of the present disclosure, a method of improving level(s) of one or more blood biomarkers associated with metabolic hormones and/or inflammation levels in a female human, including: administering to the female human a dietary supplement formulation including three or more components including a total combined daily dose of: from about 30 milligrams to about 400 milligrams of berberine; from about 50 milligrams to about 400 milligrams of grape seed extract; and from about 10 milligrams to about 200 milligrams of passionflower extract; wherein the dietary supplement formulation is administered daily for at least four weeks; wherein the three or more components act synergistically to improve level(s) of one or more blood biomarkers; and wherein the one or more blood biomarkers are selected from the group consisting of HbA1c, LDL cholesterol, and CRP.

Berberine is an isoquinoline alkaloid that may be extracted from several different plants, or a root thereof, such as Berberis aristata and has been traditionally used for antimicrobial and anti-diarrheal treatments. Without being bound by theory, berberine is proposed to have several different suggested mechanisms of action, including, but not limited to, 5′ adenosine monophosphate-activated protein kinase (“AMPK”) activation, increased glucagon-like peptide-1 (“GLP-1”) expression, and inhibition of protein tyrosine phosphatase (“PTP1B”). Berberine may be effective at improving glucose tolerance and reducing hemoglobin A1C (“HbA1c”) levels similarly to the anti-diabetic drug Metformin. Berberine may also improve inflammatory biomarker levels.

Extracts from Vitis vinifera, such as grape seed extract, may contain large amounts of polyphenols, the majority of which may be procyanidins (polymer chains of catechins), along with a small amount of free flavonol esters such as epicatechin and catechin. Grape seed extract may inhibit alpha-amylase in the intestine, which may prevent carbohydrate absorption. Grape seed extract may improve blood flow, likely by increasing endothelial nitric oxide levels. Grape seed extract may also reduce inflammation.

Passifora incarnata is a wildflower prevalent in the southern United States. Extracts of Passifora incarnata (“passionflower extract”), or aerial parts thereof, may reduce insulin resistance and inflammation levels, and may modulate mood by increasing γ-aminobutyric acid (“GABA”) levels in the brain.

Magnesium is an essential dietary mineral, but is becoming increasingly rare in modern diets. In addition to changing dietary habits, which has reduced consumption of magnesium, modern farming practices and climate change have reduced magnesium levels in most vegetables. As a result, approximately 70% of people in the United States consume less than the recommended dietary allowance of magnesium. Low consumption of dietary magnesium may increase insulin resistance and metabolic disorder. Supplementation with magnesium, for example, as magnesium oxide complexed with sunflower lecithin, may improve glucose tolerance in populations with low levels of magnesium. Magnesium may be present as a species including, but not limited to, elemental magnesium, magnesium diglycinate, and/or magnesium threonate.

Zinc is an essential dietary mineral that must be consumed daily because the body has no specialized way to store zinc for future use. Zinc is especially important for women who may become pregnant. Low levels of zinc may increase the likelihood of insulin resistance and glucose intolerance. Supplementation with zinc, for example, as zinc glycinate monohydrate, may improve insulin tolerance. Zinc supplementation may improve lipid profiles and help reduce inflammation and acne.

B vitamins, specifically vitamins B1, B6, B9, and B12, are a water-soluble class of vitamins generally found in high levels in meat, eggs, and dairy. B vitamins are critical cofactors for many metabolic processes, and low levels of B vitamins are frequently correlated with increased insulin resistance. Vitamins B6, B9, and B12 are also involved in the regulation of homocysteine. High homocysteine levels are linked with higher inflammation, and higher cardiovascular risk. Supplementation with B vitamins may reduce homocysteine levels. Thiamine (vitamin B1) may be provided in the form of thiamine HCl. Vitamin B6 may be provided in the form of pyridoxine HCl. Folate (vitamin B9) may be provided in the form of calcium L-5-methyltetrahydrofolate. Vitamin B12 may be provided in the form of cyanocobalamin.

Synergistic dietary supplement formulations administered according to examples of methods of treatment of the present disclosure may include three or more active ingredients in varying amounts as follows:

A preferred dosage range of from about 30 mg to about 400 mg of berberine, or a most preferred dosage range of from about 40 mg to about 140 mg of berberine, including, but not limited to, from about 30 mg to about 390 mg, from about 30 mg to about 380 mg, from about 30 mg to about 370 mg, from about 30 mg to about 360 mg, from about 30 mg to about 350 mg, from about 30 mg to about 340 mg, from about 30 mg to about 330 mg, from about 30 mg to about 320 mg, from about 30 mg to about 310 mg, from about 30 mg to about 300 mg, from about 30 mg to about 290 mg, from about 30 mg to about 280 mg, from about 30 mg to about 270 mg, from about 30 mg to about 260 mg, from about 30 mg to about 250 mg, from about 30 mg to about 240 mg, from about 30 mg to about 230 mg, from about 30 mg to about 220 mg, from about 30 mg to about 210 mg, from about 30 mg to about 200 mg, from about 30 mg to about 190 mg, from about 30 mg to about 180 mg, from about 30 mg to about 170 mg, from about 160 mg, from about 30 mg to about 150 mg, from about 30 mg to about 140 mg, from about 30 mg to about 130 mg, from about 30 mg to about 120 mg, from about 30 mg to about 110 mg, from about 30 mg to about 100 mg, from about 30 mg to about 90 mg, from about 30 mg to about 80 mg, from about 40 mg to about 400 mg, from about 40 mg to about 390 mg, from about 40 mg to about 380 mg, from about 40 mg to about 370 mg, from about 40 mg to about 360 mg, from about 40 mg to about 350 mg, from about 40 mg to about 340 mg, from about 40 mg to about 330 mg, from about 40 mg to about 320 mg, from about 40 mg to about 310 mg, from about 40 mg to about 300 mg, from about 40 mg to about 290 mg, from about 40 mg to about 280 mg, from about 40 mg to about 270 mg, from about 40 mg to about 260 mg, from about 40 mg to about 250 mg, from about 40 mg to about 240 mg, from about 40 mg to about 230 mg, from about 40 mg to about 220 mg, from about 40 mg to about 210 mg, from about 40 mg to about 200 mg, from about 40 mg to about 190 mg, from about 40 mg to about 180 mg, from about 40 mg to about 170 mg, from about 40 mg to about 160 mg, from about 40 mg to about 150 mg, from about 40 mg to about 130 mg, from about 40 mg to about 120 mg, from about 40 mg to about 110 mg, from about 40 mg to about 100 mg, from about 40 mg to about 90 mg, from about 40 mg to about 80 mg, from about 50 mg to about 400 mg, from about 50 mg to about 390 mg, from about 50 mg to about 380 mg, from about 50 mg to about 370 mg, from about 50 mg to about 360 mg, from about 50 mg to about 350 mg, from about 50 mg to about 340 mg, from about 50 mg to about 330 mg, from about 50 mg to about 320 mg, from about 50 mg to about 310 mg, from about 50 mg to about 300 mg, from about 50 mg to about 290 mg, from about 50 mg to about 280 mg, from about 50 mg to about 270 mg, from about 50 mg to about 260 mg, from about 50 mg to about 250 mg, from about 50 mg to about 240 mg, from about 50 mg to about 230 mg, from about 50 mg to about 220 mg, from about 50 mg to about 210 mg, from about 50 mg to about 200 mg, from about 50 mg to about 190 mg, from about 50 mg to about 180 mg, from about 50 mg to about 170 mg, from about 50 mg to about 160 mg, from about 50 mg to about 150 mg, from about 50 mg to about 140 mg, from about 50 mg to about 130 mg, from about 50 mg to about 120 mg, from about 50 mg to about 110 mg, from about 50 mg to about 100 mg, from about 50 mg to about 90 mg, from about 50 mg to about 80 mg, from about 60 mg to about 400 mg, from about 60 mg to about 390 mg, from about 60 mg to about 380 mg, from about 60 mg to about 370 mg, from about 60 mg to about 360 mg, from about 60 mg to about 350 mg, from about 60 mg to about 340 mg, from about 60 mg to about 330 mg, from about 60 mg to about 320 mg, from about 60 mg to about 310 mg, from about 60 to about 300 mg, from about 60 mg to about 290 mg, from about 60 mg to about 280 mg, from about 60 mg to about 270 mg, from about 60 mg to about 260 mg, from about 60 mg to about 250 mg, from about 60 mg to about 240 mg, from about 60 mg to about 230 mg, from about 60 mg to about 220 mg, from about 60 mg to about 210 mg, from about 60 mg to about 200 mg, from about 60 mg to about 200 mg, from about 60 mg to about 190 mg, from about 60 mg to about 180 mg, from about 60 mg to about 170 mg, from about 60 mg to about 160 mg, from about 60 mg to about 150 mg, from about 60 mg to about 140 mg, from about 60 mg to about 130 mg, from about 60 mg to about 130 mg, from about 60 mg to about 120 mg, from about 60 mg to about 110 mg, from about 60 mg to about 100 mg, from about 60 mg to about 90 mg, from about 60 mg to about 80 mg, from about 70 mg to about 400 mg, from about 70 mg to about 390 mg, from about 70 mg to about 380 mg, from about 70 mg to about 370 mg, from about 70 mg to about 360 mg, from about 70 mg to about 350 mg, from about 70 mg to about 340 mg, from about 70 mg to about 330 mg, from about 70 mg to about 320 mg, from about 70 mg to about 310 mg, from about 70 mg to about 300 mg, from about 70 mg to about 290 mg, from about 70 mg to about 280 mg, from about 70 mg to about 270 mg, from about 70 mg to about 260 mg, from about 70 mg to about 250 mg, from about 70 mg to about 240 mg, from about 70 mg to about 230 mg, from about 70 mg to about 220 mg, from about 70 mg to about 210 mg, from about 70 mg to about 200 mg, from about 70 mg to about 190 mg, from about 70 mg to about 180 mg, from about 70 mg to about 170 mg, from about 70 mg to about 160 mg, from about 70 mg to about 150 mg, from about 70 mg to about 140 mg, from about 70 mg to about 130 mg, from about 70 mg to about 120 mg, from about 70 mg to about 110 mg, from about 70 mg to about 100 mg, from about 70 mg to about 90 mg, from about 70 mg to about 80 mg, from about 80 mg to about 400 mg, from about 80 mg to about 390 mg, from about 80 mg to about 380 mg, from about 80 mg to about 370 mg, from about 80 mg to about 360 mg, from about 80 mg to about 350 mg, from about 80 mg to about 340 mg, from about 80 mg to about 330 mg, from about 80 mg to about 320 mg, from about 80 mg to about 310 mg, from about 80 mg to about 300 mg, from about 80 mg to about 290 mg, from about 80 mg to about 280 mg, from about 80 mg to about 270 mg, from about 80 mg to about 260 mg, from about 80 mg to about 250 mg, from about 80 mg to about 240 mg, from about 80 mg to about 230 mg, from about 80 mg to about 220 mg, from about 80 mg to about 210 mg, from about 80 mg to about 200 mg, from about 80 mg to about 190 mg, from about 80 mg to about 180 mg, from about 80 mg to about 170 mg, from about 80 mg to about 160 mg, from about 80 mg to about 150 mg, from about 80 mg to about 140 mg, from about 80 mg to about 130 mg, from about 80 mg to about 120 mg, from about 80 mg to about 110 mg, from about 80 mg to about 100 mg, or from about 80 mg to about 90 mg;

A preferred dosage range of from about 50 mg to about 400 mg of grape seed extract, or a most preferred dosage range of from about 90 mg to about 280 mg of grape seed extract, including, but not limited to, from about 50 mg to about 390 mg, from about 50 mg to about 380 mg, from about 50 mg to about 370 mg, from about 50 mg to about 360 mg, from about 50 mg to about 350 mg, from about 50 mg to about 340 mg, from about 50 mg to about 330 mg, from about 50 mg to about 320 mg, from about 50 mg to about 310 mg, from about 50 mg to about 300 mg, from about 50 mg to about 290 mg, from about 50 mg to about 280 mg, from about 50 mg to about 270 mg, from about 50 mg to about 260 mg, from about 50 mg to about 250 mg, from about 50 mg to about 240 mg, from about 50 mg to about 230 mg, from about 50 mg to about 220 mg, from about 50 mg to about 210 mg, from about 50 mg to about 200 mg, from about 50 mg to about 190 mg, from about 50 mg to about 180 mg, from about 60 mg to about 400 mg, from about 60 mg to about 390 mg, from about 60 mg to about 380 mg, from about 60 mg to about 370 mg, from about 60 mg to about 360 mg, from about 60 mg to about 350 mg, from about 60 mg to about 340 mg, from about 60 mg to about 330 mg, from about 60 mg to about 320 mg, from about 60 mg to about 310 mg, from about 60 mg to about 300 mg, from about 60 mg to about 290 mg, from about 60 mg to about 280 mg, from about 60 mg to about 270 mg, from about 60 mg to about 260 mg, from about 60 mg to about 250 mg, from about 60 mg to about 240 mg, from about 60 mg to about 230 mg, from about 60 mg to about 220 mg, from about 60 mg to about 210 mg, from about 60 mg to about 200 mg, from about 60 mg to about 190 mg, from about 60 mg to about 180 mg, from about 70 mg to about 400 mg, from about 70 mg to about 390 mg, from about 70 mg to about 380 mg, from about 70 mg to about 370 mg, from about 70 mg to about 360 mg, from about 70 mg to about 350 mg, from about 70 mg to about 340 mg, from about 70 mg to about 330 mg, from about 70 mg to about 320 mg, from about 70 mg to about 310 mg, from about 70 mg to about 300 mg, from about 70 mg to about 290 mg, from about 70 mg to about 280 mg, from about 70 mg to about 270 mg, from about 70 mg to about 260 mg, from about 70 mg to about 250 mg, from about 70 mg to about 240 mg, from about 70 mg to about 230 mg, from about 70 mg to about 220 mg, from about 70 mg to about 210 mg, from about 70 mg to about 200 mg, from about 70 mg to about 190 mg, from about 70 mg to about 180 mg, from about 80 mg to about 400 mg, from about 80 mg to about 390 mg, from about 80 mg to about 380 mg, from about 80 mg to about 370 mg, from about 80 mg to about 360 mg, from about 80 mg to about 350 mg, from about 80 mg to about 340 mg, from about 80 mg to about 330 mg, from about 80 mg to about 320 mg, from about 80 mg to about 310 mg, from about 80 mg to about 300 mg, from about 80 mg to about 290 mg, from about 80 mg to about 280 mg, from about 80 mg to about 270 mg, from about 80 mg to about 260 mg, from about 80 mg to about 250 mg, from about 80 mg to about 240 mg, from about 80 mg to about 230 mg, from about 80 mg to about 220 mg, from about 80 mg to about 210 mg, from about 80 mg to about 200 mg, from about 80 mg to about 190 mg, from about 80 mg to about 180 mg, from about 90 mg to about 400 mg, from about 90 mg to about 390 mg, from about 90 mg to about 380 mg, from about 90 mg to about 370 mg, from about 90 mg to about 360 mg, from about 90 mg to about 350 mg, from about 90 mg to about 340 mg, from about 90 mg to about 330 mg, from about 90 mg to about 320 mg, from about 90 mg to about 310 mg, from about 90 mg to about 300 mg, from about 90 mg to about 290 mg, from about 90 mg to about 270 mg, from about 90 mg to about 260 mg, from about 90 mg to about 250 mg, from about 90 mg to about 240 mg, from about 90 mg to about 230 mg, from about 90 mg to about 220 mg, from about 90 mg to about 210 mg, from about 90 mg to about 200 mg, from about 90 mg to about 190 mg, from about 90 mg to about 180 mg, from about 100 mg to about 400 mg, from about 100 mg to about 390 mg, from about 100 mg to about 380 mg, from about 100 mg to about 370 mg, from about 100 mg to about 360 mg, from about 100 mg to about 350 mg, from about 100 mg to about 340 mg, from about 100 mg to about 330 mg, from about 100 mg to about 320 mg, from about 100 mg to about 310 mg, from about 100 mg to about 300 mg, from about 100 mg to about 290 mg, from about 100 mg to about 280 mg, from about 100 mg to about 270 mg, from about 100 mg to about 260 mg, from about 100 mg to about 250 mg, from about 100 mg to about 240 mg, from about 100 mg to about 230 mg, from about 100 mg to about 220 mg, from about 100 mg to about 210 mg, from about 200 mg, from about 100 mg to about 190 mg, from about 100 mg to about 180 mg, from about 110 mg to about 400 mg, from about 110 mg to about 390 mg, from about 110 mg to about 380 mg, from about 110 mg to about 370 mg, from about 110 mg to about 360 mg, from about 110 mg to about 350 mg, from about 110 mg to about 340 mg, from about 110 mg to about 330 mg, from about 110 mg to about 320 mg, from about 110 mg to about 310 mg, from about 110 mg to about 300 mg, from about 110 mg to about 290 mg, from about 110 mg to about 280 mg, from about 110 mg to about 270 mg, from about 110 mg to about 260 mg, from about 110 mg to about 250 mg, from about 110 mg to about 240 mg, from about 110 mg to about 230 mg, from about 110 mg to about 220 mg, from about 110 mg to about 210 mg, from about 110 mg to about 200 mg, from about 110 mg to about 190 mg, from about 110 mg to about 180 mg, from about 120 mg to about 400 mg, from about 120 mg to about 390 mg, from about 120 mg to about 380 mg, from about 120 mg to about 370 mg, from about 120 mg to about 360 mg, from about 120 mg to about 350 mg, from about 120 mg to about 340 mg, from about 120 mg to about 330 mg, from about 120 mg to about 320 mg, from about 120 mg to about 310 mg, from about 120 mg to about 300 mg, from about 120 mg to about 290 mg, from about 120 mg to about 280 mg, from about 120 mg to about 270 mg, from about 120 mg to about 260 mg, from about 120 mg to about 250 mg, from about 120 mg to about 240 mg, from about 120 mg to about 230 mg, from about 120 mg to about 220 mg, from about 120 mg to about 210 mg, from about 120 mg to about 200 mg, from about 120 mg to about 190 mg, from about 120 mg to about 180 mg, from about 130 mg to about 400 mg, from about 130 mg to about 390 mg, from about 130 mg to about 380 mg, from about 130 mg to about 370 mg, from about 130 mg to about 360 mg, from about 130 mg to about 350 mg, from about 130 mg to about 340 mg, from about 130 mg to about 330 mg, from about 130 mg to about 320 mg, from about 130 mg to about 310 mg, from about 130 mg to about 300 mg, from about 130 mg to about 290 mg, from about 130 mg to about 280 mg, from about 130 mg to about 270 mg, from about 130 mg to about 260 mg, from about 130 mg to about 250 mg, from about 130 mg to about 240 mg, from about 130 mg to about 230 mg, from about 130 mg to about 220 mg, from about 130 mg to about 210 mg, from about 130 mg to about 200 mg, from about 130 mg to about 190 mg, from about 130 mg to about 180 mg, from about 140 mg to about 400 mg, from about 140 mg to about 390 mg, from about 140 mg to about 380 mg, from about 140 mg to about 370 mg, from about 140 mg to about 360 mg, from about 140 mg to about 350 mg, from about 140 mg to about 340 mg, from about 140 mg to about 330 mg, from about 140 mg to about 320 mg, from about 140 mg to about 310 mg, from about 140 mg to about 300 mg, from about 140 mg to about 290 mg, from about 140 mg to about 280 mg, from about 140 mg to about 270 mg, from about 140 mg to about 260 mg, from about 140 mg to about 250 mg, from about 140 mg to about 240 mg, from about 140 mg to about 230 mg, from about 140 mg to about 220 mg, from about 140 mg to about 210 mg, from about 140 mg to about 200 mg, from about 140 gm to about 190 mg, from about 140 mg to about 180 mg, from about 150 mg to about 400 mg, from about 150 mg to about 390 mg, from about 150 mg to about 380 mg, from about 150 mg to about 370 mg, from about 150 mg to about 360 mg, from about 150 mg to about 350 mg, from about 150 mg to about 340 mg, from about 150 mg to about 330 mg, from about 150 mg to about 320 mg, from about 150 mg to about 310 mg, from about 150 mg to about 300 mg, from about 150 mg to about 290 mg, from about 150 mg to about 280 mg, from about 150 mg to about 270 mg, from about 150 mg to about 260 mg, from about 150 mg to about 250 mg, from about 150 mg to about 240 mg, from about 150 mg to about 230 mg, from about 150 mg to about 220 mg, from about 150 mg to about 210 mg, from about 150 mg to about 200 mg, from about 150 mg to about 190 mg, from about 150 mg to about 180 mg, from about 160 mg to about 400 mg, from about 160 mg to about 390 mg, from about 160 mg to about 380 mg, from about 160 mg to about 370 mg, from about 160 mg to about 380 mg, from about 160 mg to about 370 mg, from about 160 mg to about 360 mg, from about 160 mg to about 350 mg, from about 160 mg to about 340 mg, from about 160 mg to about 330 mg, from about 160 mg to about 320 mg, from about 160 mg to about 310 mg, from about 160 mg to about 300 mg, from about 160 mg to about 290 mg, from about 160 mg to about 280 mg, from about 160 mg to about 270 mg, from about 160 mg to about 260 mg, from about 160 mg to about 250 mg, from about 160 mg to about 240 mg, from about 160 mg to about 230 mg, from about 160 mg to about 220 mg, from about 160 mg to about 210 mg, from about 160 mg to about 200 mg, from about 160 mg to about 190 mg, from about 160 mg to about 180 mg, from about 170 mg to about 400 mg, from about 170 mg to about 390 mg, from about 170 mg to about 380 mg, from about 170 mg to about 370 mg, from about 170 mg to about 360 mg, from about 170 mg to about 350 mg, from about 170 mg to about 340 mg, from about 170 mg to about 330 mg, from about 170 mg to about 320 mg, from about 170 mg to about 310 mg, from about 170 mg to about 300 mg, from about 170 mg to about 290 mg, from about 170 mg to about 280 mg, from about 170 mg to about 270 mg, from about 170 mg to about 260 mg, from about 170 mg to about 250 mg, from about 170 mg to about 240 mg, from about 170 mg to about 230 mg, from about 170 mg to about 220 mg, from about 170 mg to about 210 mg, from about 170 mg to about 200 mg, from about 170 mg to about 190 mg, from about 170 mg to about 180 mg, from about 180 mg to about 400 mg, from about 180 mg to about 390 mg, from about 180 mg to about 380 mg, from about 180 mg to about 370 mg, from about 180 mg to about 360 mg, from about 180 mg to about 350 mg, from about 180 mg to about 340 mg, from about 180 mg to about 330 mg, from about 180 mg to about 320 mg, from about 180 mg to about 310 mg, from about 180 mg to about 300 mg, from about 180 mg to about 290 mg, from about 180 mg to about 280 mg, from about 180 mg to about 270 mg, from about 180 mg to about 260 mg, from about 180 mg to about 250 mg, from about 180 mg to about 240 mg, from about 180 mg to about 230 mg, from about 180 mg to about 220 mg, from about 180 mg to about 210 mg, from about 180 mg to about 200 mg, or from about 180 mg to about 190 mg;

A preferred dosage range of from about 10 mg to about 200 mg of passionflower extract, or a most preferred dosage range of from about 30 mg to about 140 mg of passionflower extract, including, but not limited to, from about 10 mg to about 190 mg, from about 10 mg to about 180 mg, from about 10 mg to about 170 mg, from about 10 mg to about 160 mg, from about 10 mg to about 150 mg, from about 10 mg to about 140 mg, from about 10 mg to about 130 mg, from about 10 mg to about 120 mg, from about 10 mg to about 110 mg, from about 10 mg to about 100 mg, from about 10 mg to about 90 mg, from about 10 mg to about 80 mg, from about 20 mg to about 200 mg, from about 20 mg to about 190 mg, from about 20 mg to about 180 mg, from about 20 mg to about 170 mg, from about 20 mg to about 160 mg, from about 20 mg to about 150 mg, from about 20 mg to about 140 mg, from about 20 mg to about 130 mg, from about 20 mg to about 120 mg, from about 20 mg to about 110 mg, from about 20 mg to about 100 mg, from about 20 mg to about 90 mg, from about 20 mg to about 80 mg, from about 30 mg to about 200 mg, from about 30 mg to about 190 mg, from about 30 mg to about 180 mg, from about 30 mg to about 170 mg, from about 30 mg to about 160 mg, from about 30 mg to about 150 mg, from about 30 mg to about 130 mg, from about 30 mg to about 120 mg, from about 30 mg to about 110 mg, from about 30 mg to about 100 mg, from about 30 mg to about 90 mg, from about 30 mg to about 80 mg, from about 40 mg to about 200 mg, from about 40 mg to about 190 mg, from about 40 mg to about 180 mg, from about 40 mg to about 170 mg, from about 40 mg to about 160 mg, from about 40 mg to about 150 mg, from about 40 mg to about 140 mg, from about 40 mg to about 130 mg, from about 40 mg to about 120 mg, from about 40 mg to about 110 mg, from about 40 mg to about 100 mg, from about 40 mg to about 90 mg, from about 40 mg to about 80 mg, from about 50 mg to about 200 mg, from about 50 mg to about 190 mg, from about 50 mg to about 180 mg, from about 50 mg to about 170 mg, from about 50 mg to about 160 mg, from about 50 mg to about 150 mg, from about 50 mg to about 140 mg, from about 50 mg to about 130 mg, from about 50 mg to about 120 mg, from about 50 mg to about 110 mg, from about 50 mg to about 100 mg, from about 50 mg to about 90 mg, from about 50 mg to about 80 mg, from about 60 mg to about 200 mg, from about 60 mg to about 190 mg, from about 60 mg to about 180 mg, from about 60 mg to about 170 mg, from about 60 mg to about 160 mg, from about 60 mg to about 150 mg, from about 60 mg to about 140 mg, from about 60 mg to about 130 mg, from about 60 mg to about 120 mg, from about 60 mg to about 110 mg, from about 60 mg to about 100 mg, from about 60 mg to about 90 mg, from about 60 mg to about 80 mg, from about 70 mg to about 200 mg, from about 70 mg to about 190 mg, from about 70 mg to about 180 mg, from about 70 mg to about 170 mg, from about 70 mg to about 160 mg, from about 70 mg to about 150 mg, from about 70 mg to about 140 mg, from about 70 mg to about 130 mg, from about 70 mg to about 120 mg, from about 70 mg to about 110 mg, from about 70 mg to about 100 mg, from about 70 mg to about 90 mg, from about 70 mg to about 80 mg, from about 80 mg to about 200 mg, from about 80 mg to about 190 mg, from about 80 mg to about 180 mg, from about 80 mg to about 180 mg, from about 80 mg to about 170 mg, from about 80 mg to about 160 mg, from about 80 mg to about 150 mg, from about 80 mg to about 140 mg, from about 80 mg to about 130 mg, from about 80 mg to about 120 mg, from about 80 mg to about 110 mg, from about 80 mg to about 100 mg, or from about 80 mg to about 90 mg;

A preferred dosage range of from about 1 mg to about 100 mg of magnesium, or a most preferred dosage range of from about 5 mg to about 40 mg of magnesium, including, but not limited to, from about 1 mg to about 95 mg, from about 1 mg to about 90 mg, from about 1 mg to about 85 mg, from about 1 mg to about 80 mg, from about 1 mg to about 75 mg, from about 1 mg to about 70 mg, from about 1 mg to about 65 mg, from about 1 mg to about 60 mg, from about 1 mg to about 55 mg, from about 1 mg to about 50 mg, from about 1 mg to about 45 mg, from about 1 mg to about 40 mg, from about 1 mg to about 35 mg, from about 1 mg to about 30 mg, from about 1 mg to about 25 mg, from about 1 mg to about 20 mg, from about 3 mg to about 100 mg, from about 3 mg to about 95 mg, from about 3 mg to about 90 mg, from about 3 mg to about 85 mg, from about 3 mg to about 80 mg, from about 3 mg to about 75 mg, from about 3 mg to about 70 mg, from about 3 mg to about 65 mg, from about 3 mg to about 60 mg, from about 3 mg to about 55 mg, from about 3 mg to about 50 mg, from about 3 mg to about 45 mg, from about 3 mg to about 40 mg, from about 3 mg to about 35 mg, from about 3 mg to about 30 mg, from about 3 mg to about 25 mg, from about 3 mg to about 20 mg, from about 5 mg to about 100 mg, from about 5 mg to about 95 mg, from about 5 mg to about 90 mg, from about 5 mg to about 85 mg, from about 5 mg to about 80 mg, from about 5 mg to about 75 mg, from about 5 mg to about 70 mg, from about 5 mg to about 65 mg, from about 5 mg to about 60 mg, from about 5 mg to about 55 mg, from about 5 mg to about 50 mg, from about 5 mg to about 45 mg, from about 5 mg to about 35 mg, from about 5 mg to about 30 mg, from about 5 mg to about 25 mg, from about 5 mg to about 20 mg, from about 7 mg to about 100 mg, from about 7 mg to about 95 mg, from about 7 mg to about 90 mg, from about 7 mg to about 85 mg, from about 7 mg to about 80 mg, from about 7 mg to about 75 mg, from about 7 mg to about 70 mg, from about 7 mg to about 65 mg, from about 7 mg to about 60 mg, from about 7 mg to about 55 mg, from about 7 mg to about 50 mg, from about 7 mg to about 45 mg, from about 7 mg to about 40 mg, from about 7 mg to about 35 mg, from about 7 mg to about 30 mg, from about 7 mg to about 25 mg, from about 7 mg to about 20 mg, from about 9 mg to about 100 mg, from about 9 mg to about 95 mg, from about 9 mg to about 90 mg, from about 9 mg to about 85 mg, from about 9 mg to about 80 mg, from about 9 mg to about 75 mg, from about 9 mg to about 70 mg, from about 9 mg to about 65 mg, from about 9 mg to about 60 mg, from about 9 mg to about 55 mg, from about 9 mg to about 50 mg, from about 9 mg to about 45 mg, from about 9 mg to about 40 mg, from about 9 mg to about 35 mg, from about 9 mg to about 30 mg, from about 9 mg to about 25 mg, from about 9 mg to about 20 mg, from about 11 mg to about 100 mg, from about 11 mg to about 95 mg, from about 11 mg to about 90 mg, from about 11 mg to about 85 mg, from about 11 mg to about 80 mg, from about 11 mg to about 75 mg, from about 11 mg to about 70 mg, from about 11 mg to about 65 mg, from about 11 mg to about 60 mg, from about 11 mg to about 55 mg, from about 11 mg to about 50 mg, from about 11 mg to about 45 mg, from about 11 mg to about 40 mg, from about 11 mg to about 35 mg, from about 11 mg to about 30 mg, from about 11 mg to about 25 mg, from about 11 mg to about 20 mg, from about 13 mg to about 100 mg, from about 13 mg to about 95 mg, from about 13 mg to about 90 mg, from about 13 mg to about 85 mg, from about 13 mg to about 80 mg, from about 13 mg to about 75 mg, from about 13 mg to about 70 mg, from about 13 mg to about 65 mg, from about 13 mg to about 60 mg, from about 13 mg to about 55 mg, from about 13 mg to about 50 mg, from about 13 mg to about 45 mg, from about 13 mg to about 40 mg, from about 13 mg to about 35 mg, from about 13 mg to about 30 mg, from about 13 mg to about 25 mg, from about 13 mg to about 20 mg, from about 15 mg to about 100 mg, from about 15 mg to about 95 mg, from about 15 mg to about 90 mg, from about 15 mg to about 85 mg, from about 15 mg to about 80 mg, from about 15 mg to about 75 mg, from about 15 mg to about 70 mg, from about 15 mg to about 65 mg, from about 15 mg to about 60 mg, from about 15 mg to about 55 mg, from about 15 mg to about 50 mg, from about 15 mg to about 45 mg, from about 15 mg to about 40 mg, from about 15 mg to about 35 mg, from about 15 mg to about 30 mg, from about 15 mg to about 25 mg, from about 15 mg to about 20 mg, from about 17 mg to about 100 mg, from about 17 mg to about 90 mg, from about 17 mg to about 85 mg, from about 17 mg to about 80 mg, from about 17 mg to about 75 mg, from about 17 mg to about 70 mg, from about 17 mg to about 65 mg, from about 17 mg to about 60 mg, from about 17 mg to about 55 mg, from about 17 mg to about 50 mg, from about 17 mg to about 45 mg, from about 17 mg to about 40 mg, from about 17 mg to about 35 mg, from about 17 mg to about 30 mg, from about 17 mg to about 25 mg, from about 17 mg to about 20 mg, from about 19 mg to about 100 mg, from about 19 mg to about 95 mg, from about 19 mg to about 90 mg, from about 19 mg to about 85 mg, from about 19 mg to about 80 mg, from about 19 mg to about 75 mg, from about 19 mg to about 70 mg, from about 19 mg to about 65 mg, from about 19 mg to about 60 mg, from about 19 mg to about 55 mg, from about 19 mg to about 50 mg, from about 19 mg to about 45 mg, from about 19 mg to about 40 mg, from about 19 mg to about 35 mg, from about 19 mg to about 30 mg, from about 19 mg to about 25 mg, or from about 19 mg to about 20 mg;

A preferred dosage range of from about 1 mg to about 60 mg of zinc, or a most preferred dosage range of from about 2 mg to about 30 mg of zinc, including, but not limited to, from about 1 mg to about 58 mg, from about 1 mg to about 56 mg, from about 1 mg to about 54 mg, from about 1 mg to about 52 mg, from about 1 mg to about 50 mg, from about 1 mg to about 48 mg, from about 1 mg to about 46 mg, from about 1 mg to about 44 mg, from about 1 mg to about 42 mg, from about 1 mg to about 40 mg, from about 1 mg to about 38 mg, from about 1 mg to about 36 mg, from about 1 mg to about 34 mg, from about 1 mg to about 32 mg, from about 1 mg to about 30 mg, from about 1 mg to about 28 mg, from about 1 mg to about 26 mg, from about 1 mg to about 24 mg, from about 1 mg to about 22 mg, from about 1 mg to about 20 mg, from about 2 mg to about 60 mg, from about 2 mg to about 58 mg, from about 2 mg to about 56 mg, from about 2 mg to about 54 mg, from about 2 mg to about 52 mg, from about 2 mg to about 50 mg, from about 2 mg to about 48 mg, from about 2 mg to about 46 mg, from about 2 mg to about 44 mg, from about 2 mg to about 42 mg, from about 2 mg to about 40 mg, from about 2 mg to about 38 mg, from about 2 mg to about 36 mg, from about 2 mg to about 34 mg, from about 2 mg to about 32 mg, from about 2 mg to about 28 mg, from about 2 mg to about 26 mg, from about 2 mg to about 24 mg, from about 2 mg to about 22 mg, from about 2 mg to about 20 mg, from about 4 mg to about 60 mg, from about 4 mg to about 58 mg, from about 4 mg to about 56 mg, from about 4 mg to about 54 mg, from about 4 mg to about 52 mg, from about 4 mg to about 50 mg, from about 4 mg to about 48 mg, from about 4 mg to about 46 mg, from about 4 mg to about 44 mg, from about 4 mg to about 42 mg, from about 4 mg to about 40 mg, from about 4 mg to about 38 mg, from about 4 mg to about 36 mg, from about 4 mg to about 34 mg, from about 4 mg to about 32 mg, from about 4 mg to about 30 mg, from about 4 mg to about 28 mg, from about 4 mg to about 26 mg, from about 4 mg to about 24 mg, from about 4 mg to about 22 mg, from about 4 mg to about 20 mg, from about 6 mg to about 60 mg, from about 6 mg to about 58 mg, from about 6 mg to about 56 mg, from about 6 mg to about 54 mg, from about 6 mg to about 52 mg, from about 6 mg to about 50 mg, from about 6 mg to about 48 mg, from about 6 mg to about 46 mg, from about 6 mg to about 44 mg, from about 6 mg to about 42 mg, from about 6 mg to about 40 mg, from about 6 mg to about 38 mg, from about 6 mg to about 36 mg, from about 34 mg, from about 6 mg to about 32 mg, from about 6 mg to about 30 mg, from about 6 mg to about 28 mg, from about 6 mg to about 26 mg, from about 6 mg to about 24 mg, from about 6 mg to about 22 mg, from about 6 mg to about 20 mg, from about 8 mg to about 60 mg, from about 8 mg to about 58 mg, from about 8 mg to about 56 mg, from about 8 mg to about 54 mg, from about 8 mg to about 52 mg, from about 8 mg to about 50 mg, from about 8 mg to about 48 mg, from about 8 mg to about 46 mg, from about 8 mg to about 44 mg, from about 8 mg to about 42 mg, from about 8 mg to about 40 mg, from about 8 mg to about 38 mg, from about 8 mg to about 36 mg, from about 8 mg to about 34 mg, from about 8 mg to about 32 mg, from about 8 mg to about 30 mg, from about 8 mg to about 28 mg, from about 8 mg to about 26 mg, from about 8 mg to about 24 mg, from about 8 mg to about 22 mg, from about 8 mg to about 20 mg, from about 10 mg to about 60 mg, from about 10 mg to about 58 mg, from about 10 mg to about 56 mg, from about 10 mg to about 54 mg, from about 10 mg to about 52 mg, from about 10 mg to about 50 mg, from about 10 mg to about 48 mg, from about 10 mg to about 46 mg, from about 10 mg to about 44 mg, from about 10 mg to about 42 mg, from about 10 mg to about 40 mg, from about 10 mg to about 38 mg, from about 10 mg to about 36 mg, from about 10 mg to about 34 mg, from about 10 mg to about 32 mg, from about 10 mg to about 30 mg, from about 10 mg to about 28 mg, from about 10 mg to about 26 mg, from about 10 mg to about 24 mg, from about 10 mg to about 22 mg, from about 10 mg to about 20 mg, from about 12 mg to about 60 mg, from about 12 mg to about 58 mg, from about 12 mg to about 56 mg, from about 12 mg to about 54 mg, from about 12 mg to about 52 mg, from about 12 mg to about 50 mg, from about 12 mg to about 48 mg, from about 12 mg to about 46 mg, from about 12 mg to about 44 mg, from about 12 mg to about 42 mg, from about 12 mg to about 40 mg, from about 12 mg to about 38 mg, from about 12 mg to about 36 mg, from about 12 mg to about 34 mg, from about 12 mg to about 32 mg, from about 12 mg to about 30 mg, from about 12 mg to about 28 mg, from about 12 mg to about 26 mg, from about 12 mg to about 24 mg, from about 12 mg to about 22 mg, from about 12 mg to about 20 mg, from about 14 mg to about 60 mg, from about 14 mg to about 58 mg, from about 14 mg to about 56 mg, from about 14 mg to about 54 mg, from about 14 mg to about 52 mg, from about 14 mg to about 50 mg, from about 14 mg to about 48 mg, from about 14 mg to about 46 mg, from about 14 mg to about 44 mg, from about 14 mg to about 42 mg, from about 14 mg to about 40 mg, from about 14 mg to about 38 mg, from about 14 mg to about 36 mg, from about 14 mg to about 34 mg, from about 14 mg to about 32 mg, from about 14 mg to about 30 mg, from about 14 mg to about 28 mg, from about 14 mg to about 26 mg, from about 14 mg to about 24 mg, from about 14 mg to about 22 mg, from about 14 mg to about 20 mg, from about 16 mg to about 60 mg, from about 16 mg to about 58 mg, from about 16 mg to about 56 mg, from about 16 mg to about 56 mg, from about 16 mg to about 54 mg, from about 16 mg to about 52 mg, from about 16 mg to about 50 mg, from about 16 mg to about 48 mg, from about 16 mg to about 46 mg, from about 16 mg to about 44 mg, from about 16 mg to about 42 mg, from about 16 mg to about 40 mg, from about 16 mg to about 38 mg, from about 16 mg to about 36 mg, from about 16 mg to about 34 mg, from about 16 mg to about 32 mg, from about 16 mg to about 30 mg, from about 16 mg to about 28 mg, from about 16 mg to about 26 mg, from about 16 mg to about 24 mg, from about 16 mg to about 22 mg, from about 16 mg to about 20 mg, from about 18 mg to about 60 mg, from about 18 mg to about 58 mg, from about 18 mg to about 56 mg, from about 18 mg to about 54 mg, from about 18 mg to about 52 mg, from about 18 mg to about 50 mg, from about 18 mg to about 48 mg, from about 18 mg to about 46 mg, from about 18 mg to about 44 mg, from about 18 mg to about 42 mg, from about 18 mg to about 40 mg, from about 18 mg to about 38 mg, from about 18 mg to about 36 mg, from about 18 mg to about 34 mg, from about 18 mg to about 32 mg, from about 18 mg to about 30 mg, from about 18 mg to about 28 mg, from about 18 mg to about 26 mg, from about 18 mg to about 24 mg, from about 18 mg to about 22 mg, from about 18 mg to about 20 mg, from about 20 mg to about 60 mg, from about 20 mg to about 58 mg, from about 20 mg to about 56 mg, from about 20 mg to about 54 mg, from about 20 mg to about 52 mg, from about 20 mg to about 50 mg, from about 20 mg to about 48 mg, from about 20 mg to about 46 mg, from about 20 mg to about 44 mg, from about 20 mg to about 42 mg, from about 20 mg to about 40 mg, from about 20 mg to about 38 mg, from about 20 mg to about 36 mg, from about 20 mg to about 34 mg, from about 20 mg to about 32 mg, from about 20 mg to about 30 mg, from about 20 mg to about 28 mg, from about 20 mg to about 26 mg, from about 20 mg to about 24 mg, or from about 20 mg to about 22 mg;

A preferred dosage range of from about 1 mg to about 30 mg of vitamin B1, and/or from about 1 mg to about 30 mg of vitamin B6, or a most preferred dosage range of from about 2 mg to about 25 mg of vitamin B1, and/or a most preferred dosage range of from about 2 mg to about 25 mg of vitamin B6, including, but not limited to, independently, for each of vitamin B1 and vitamin B6, from about 1 mg to about 29 mg, from about 1 mg to about 28 mg, from about 1 mg to about 27 mg, from about 1 mg or about 26 mg, from about 1 mg to about 25 mg, from about 1 mg to about 24 mg, from about 1 mg to about 24 mg, from about 1 mg to about 23 mg, from about 1 mg to about 22 mg, from about 1 mg to about 21 mg, from about 1 mg to about 20 mg, from about 2 mg to about 30 mg, from about 2 mg to about 29 mg, from about 2 mg to about 28 mg, from about 2 mg to about 27 mg, from about 2 mg to about 26 mg, from about 2 mg to about 24 mg, from about 2 mg to about 23 mg, from about 2 mg to about 22 mg, from about 2 mg to about 21 mg, from about 2 mg to about 20 mg, from about 3 mg to about 30 mg, from about 3 mg to about 29 mg, from about 3 mg to about 28 mg, from about 3 mg to about 27 mg, from about 3 mg to about 26 mg, from about 3 mg to about 25 mg, from about 3 mg to about 24 mg, from about 3 mg to about 23 mg, from about 3 mg to about 22 mg, from about 3 mg to about 21 mg, from about 3 mg to about 20 mg, from about 4 mg to about 30 mg, from about 4 mg to about 29 mg, from about 4 mg to about 28 mg, from about 4 mg to about 27 mg, from about 4 mg to about 26 mg, from about 4 mg to about 25 mg, from about 4 mg to about 24 mg, from about 4 mg to about 23 mg, from about 4 mg to about 22 mg, from about 4 mg to about 21 mg, from about 4 mg to about 20 mg, from about 5 mg to about 30 mg, from about 5 mg to about 29 mg, from about 5 mg to about 28 mg, from about 5 mg to about 27 mg, from about 5 mg to about 26 mg, from about 5 mg to about 25 mg, from about 5 mg to about 24 mg, from about 5 mg to about 23 mg, from about 5 mg to about 22 mg, from about 5 mg to about 21 mg, from about 5 mg to about 20 mg, from about 6 mg to about 30 mg, from about 6 mg to about 29 mg, from about 6 mg to about 28 mg, from about 6 mg to about 27 mg, from about 6 mg to about 26 mg, from about 6 mg to about 25 mg, from about 6 mg to about 24 mg, from about 6 mg to about 23 mg, from about 6 mg to about 22 mg, from about 6 mg to about 21 mg, from about 6 mg to about 20 mg, from about 7 mg to about 30 mg, from about 7 mg to about 29 mg, from about 7 mg to about 28 mg, from about 7 mg to about 27 mg, from about 7 mg to about 26 mg, from about 7 mg to about 25 mg, from about 7 mg to about 24 mg, from about 7 mg to about 23 mg, from about 7 mg to about 22 mg, from about 7 mg to about 21 mg, from about 7 mg to about 20 mg, from about 8 mg to about 30 mg, from about 8 mg to about 29 mg, from about 8 mg to about 28 mg, from about 8 mg to about 27 mg, from about 8 mg to about 26 mg, from about 8 mg to about 25 mg, from about 8 mg to about 24 mg, from about 8 mg to about 23 mg, from about 8 mg to about 22 mg, from about 8 mg to about 21 mg, from about 8 mg to about 20 mg, from about 9 mg to about 30 mg, from about 9 mg to about 29 mg, from about 9 mg to about 28 mg, from about 9 mg to about 27 mg, from about 9 mg to about 26 mg, from about 9 mg to about 25 mg, from about 9 mg to about 24 mg, from about 9 mg to about 23 mg, from about 9 mg to about 22 mg, from about 9 mg to about 21 mg, from about 9 mg to about 20 mg, from about 10 mg to about 30 mg, from about 10 mg to about 29 mg, from about 10 mg to about 28 mg, from about 10 mg to about 27 mg, from about 10 mg to about 26 mg, from about 10 mg to about 25 mg, from about 10 mg to about 24 mg, from about 10 mg to about 23 mg, from about 10 mg to about 22 mg, from about 10 mg to about 21 mg, from about 10 mg to about 20 mg, from about 11 mg to about 30 mg, from about 11 mg to about 29 mg, from about 11 mg to about 28 mg, from about 11 mg to about 27 mg, from about 11 mg to about 26 mg, from about 11 mg to about 25 mg, from about 11 mg to about 24 mg, from about 11 mg to about 23 mg, from about 11 mg to about 22 mg, from about 11 mg to about 21 mg, from about 11 mg to about 20 mg, from about 12 mg to about 30 mg, from about 12 mg to about 29 mg, from about 12 mg to about 28 mg, from about 12 mg to about 27 mg, from about 12 mg to about 26 mg, from about 12 mg to about 25 mg, from about 12 mg to about 24 mg, from about 12 mg to about 23 mg, from about 12 mg to about 22 mg, from about 12 mg to about 21 mg, from about 12 mg to about 20 mg, from about 13 mg to about 30 mg, from about 13 mg to about 29 mg, from about 13 mg to about 28 mg, from about 13 mg to about 27 mg, from about 13 mg to about 26 mg, from about 13 mg to about 25 mg, from about 13 mg to about 24 mg, from about 13 mg to about 23 mg, from about 13 mg to about 22 mg, from about 13 mg to about 21 mg, from about 13 mg to about 20 mg, from about 14 mg to about 30 mg, from about 14 mg to about 29 mg, from about 14 mg to about 28 mg, from about 14 mg to about 27 mg, from about 14 mg to about 26 mg, from about 14 mg to about 25 mg, from about 14 mg to about 24 mg, from about 14 mg to about 23 mg, from about 14 mg to about 22 mg, from about 14 mg to about 21 mg, from about 14 mg to about 20 mg, from about 15 mg to about 30 mg, from about 15 mg to about 29 mg, from about 15 mg to about 28 mg, from about 15 mg to about 27 mg, from about 15 mg to about 26 mg, from about 15 mg to about 25 mg, from about 15 mg to about 24 mg, from about 15 mg to about 23 mg, from about 15 mg to about 22 mg, from about 15 mg to about 21 mg, from about 15 mg to about 20 mg, from about 16 mg to about 30 mg, from about 16 mg to about 29 mg, from about 16 mg to about 28 mg, from about 16 mg to about 27 mg, from about 16 mg to about 26 mg, from about 16 mg to about 25 mg, from about 16 mg to about 24 mg, from about 16 mg to about 23 mg, from about 16 mg to about 22 mg, from about 16 mg to about 21 mg, from about 16 mg to about 20 mg, from about 17 mg to about 30 mg, from about 17 mg to about 29 mg, from about 17 mg to about 28 mg, from about 17 mg to about 27 mg, from about 17 mg to about 26 mg, from about 17 mg to about 25 mg, from about 17 mg to about 24 mg, from about 17 mg to about 23 mg, from about 17 mg to about 22 mg, from about 17 mg to about 21 mg, from about 17 mg to about 20 mg, from about 18 mg to about 30 mg, from about 18 mg to about 29 mg, from about 18 mg to about 28 mg, from about 18 mg to about 27 mg, from about 18 mg to about 26 mg, from about 18 mg to about 25 mg, from about 18 mg to about 24 mg, from about 18 mg to about 23 mg, from about 18 mg to about 22 mg, from about 18 mg to about 21 mg, from about 18 mg to about 20 mg, from about 19 mg to about 30 mg, from about 19 mg to about 29 mg, from about 19 mg to about 28 mg, from about 19 mg to about 27 mg, from about 19 mg to about 26 mg, from about 19 mg to about 25 mg, from about 19 mg to about 24 mg, from about 19 mg to about 23 mg, from about 19 mg to about 22 mg, from about 19 mg to about 21 mg, from about 19 mg to about 20 mg, from about 20 mg to about 30 mg, from about 20 mg to about 29 mg, from about 20 mg to about 28 mg, from about 20 mg to about 27 mg, from about 20 mg to about 26 mg, from about 20 mg to about 25 mg, from about 20 mg to about 24 mg, from about 20 mg to about 23 mg, from about 20 mg to about 22 mg, or from about 20 mg to about 21 mg;

A preferred dosage range of from about 150 mcg (or μg) to about 900 mcg dietary folate equivalent (“DFE”) of vitamin B9, or a most preferred dosage range of from about 300 mcg to about 800 mcg of vitamin B9, including, but not limited to, from about 150 mcg to about 890 mcg, or from about 150 mcg to about 880 mcg, or from about 150 mcg to about 870 mcg, or from about 150 mcg to about 860 mcg, or from about 150 mcg to about 850 mcg, or from about 150 mcg to about 840 mcg, or from about 150 mcg to about 830 mcg, or from about 150 mcg to about 820 mcg, or from about 150 mcg to about 810 mcg, or from about 150 mcg to about 800 mcg, or from about 150 mcg to about 790 mcg, or from about 150 mcg to about 780 mcg, or from about 150 mcg to about 770 mcg, or from about 150 mcg to about 760 mcg, or from about 150 mcg to about 750 mcg, or from about 150 mcg to about 740 mcg, or from about 150 mcg to about 730 mg, or from about 150 mcg to about 720 mcg, or from about 150 mcg to about 710 mcg, or from about 150 mcg to about 700 mcg, or from about 150 mcg to about 690 mcg, or from about 150 mcg to about 680 mcg, or from about 160 mg to about 900 mcg, or from about 160 mcg to about 880 mcg, or from about 160 mcg to about 860 mcg, or from about 160 mcg to about 840 mcg, or from about 160 mcg to about 820 mcg, or from about 160 mcg to about 800 mcg, or from about 160 mcg to about 780 mcg, or from about 160 mcg to about 760 mcg, or from about 160 mcg to about 740 mcg, or from about 160 mcg to about 720 mcg, or from about 160 mcg to about 700 mcg, or from about 160 mcg to about 680 mcg, or from about 180 mcg to about 900 mcg, or from about 180 mcg to about 880 mcg, or from about 180 mcg to about 860 mcg, or from about 180 mcg to about 840 mcg, or from about 180 mcg to about 820 mcg, or from about 180 mcg to about 800 mcg, or from about 180 mcg to about 780 mcg, or from about 180 mcg to about 760 mcg, or from about 180 mcg to about 740 mcg, or from about 180 mcg to about 720 mcg, or from about 180 mcg to about 700 mcg, or from about 180 mcg to about 680 mcg, from about 200 mcg to about 900 mcg, from about 200 mcg to about 880 mcg, from about 200 mcg to about 860 mcg, from about 200 mcg to about 840 mcg, from about 200 mcg to about 820 mcg, from about 200 mcg to about 800 mcg, from about 200 mcg to about 780 mcg, from about 200 mcg to about 760 mcg, from about 200 mcg to about 740 mcg, from about 200 mcg to about 720 mcg, from about 200 mcg to about 700 mcg, from about 200 mcg to about 680 mcg, from about 220 mcg to about 900 mcg, from about 220 mcg to about 880 mcg, from about 220 mcg to about 860 mcg, from about 220 mcg to about 840 mcg, from about 220 mcg to about 820 mcg, from about 220 mcg to about 800 mcg, from about 220 mcg to about 780 mcg, from about 220 mcg to about 760 mcg, from about 220 mcg to about 740 mcg, from about 220 mcg to about 720 mcg, from about 220 mcg to about 700 mcg, from about 220 mcg to about 680 mcg, from about 240 mcg to about 900 mcg, from about 240 mcg to about 880 mcg, from about 240 mcg to about 860 mcg, from about 240 mcg to about 840 mcg, from about 240 mcg to about 820 mcg, from about 240 mcg to about 800 mcg, from about 240 mcg to about 780 mcg, from about 240 mcg to about 760 mcg, from about 240 mcg to about 740 mcg, from about 240 mcg to about 720 mcg, from about 240 mcg to about 700 mcg, from about 240 mcg to about 680 mcg, from about 260 mcg to about 900 mcg, from about 260 mcg to about 880 mcg, from about 260 mcg to about 860 mcg, from about 260 mcg to about 840 mcg, from about 260 mcg to about 820 mcg, from about 260 mcg to about 800 mcg, from about 260 mcg to about 780 mcg, from about 260 mcg to about 760 mcg, from about 260 mcg to about 740 mcg, from about 260 mcg to about 720 mcg, from about 260 mcg to about 700 mcg, from about 260 mcg to about 680 mcg, from about 280 mcg to about 900 mcg, from about 280 mcg to about 880 mcg, from about 280 mcg to about 860 mcg, from about 280 mcg to about 840 mcg, from about 280 mcg to about 820 mcg, from about 280 mcg to about 800 mcg, from about 280 mcg to about 780 mcg, from about 280 mcg to about 760 mcg, from about 280 mcg to about 740 mcg, from about 280 mcg to about 720 mcg, from about 280 mcg to about 700 mcg, from about 280 mcg to about 680 mcg, from about 300 mcg to about 900 mcg, from about 300 mcg to about 880 mcg, from about 300 mcg to about 860 mcg, from about 300 mcg to about 840 mcg, from about 300 mcg to about 820 mcg, from about 300 mcg to about 780 mcg, from about 300 mcg to about 760 mcg, from about 300 mcg to about 740 mcg, from about 300 mcg to about 720 mcg, from about 300 mcg to about 700 mcg, from about 300 mcg to about 680 mcg, from about 310 mcg to about 680 mcg, from about 320 mcg to about 680 mcg, from about 330 mcg to about 680 mcg, from about 340 mcg to about 680 mcg, from about 350 mcg to about 680 mcg, from about 360 mcg to about 680 mcg, from about 370 mcg to about 680 mcg, from about 380 mcg to about 680 mcg, from about 390 mcg to about 680 mcg, from about 400 mcg to about 680 mcg, from about 410 mcg to about 680 mcg, from about 420 mcg to about 680 mcg, from about 430 mcg to about 680 mcg, from about 440 mcg to about 680 mcg, from about 450 mcg to about 680 mcg, from about 460 mcg to about 680 mcg, from about 470 mcg to about 680 mcg, from about 480 mcg to about 680 mcg, from about 490 mcg to about 680 mcg, from about 500 mcg to about 680 mcg, from about 510 mcg to about 680 mcg, from about 520 mcg to about 680 mcg, from about 530 mcg to about 680 mcg, from about 540 mcg to about 680 mcg, from about 550 mcg to about 680 mcg, from about 560 mcg to about 680 mcg, from about 570 mcg to about 680 mcg, from about 580 mcg to about 680 mcg, from about 590 mcg to about 680 mcg, from about 600 mcg to about 680 mcg, from about 610 mcg to about 680 mcg, from about 620 mcg to about 680 mcg, from about 630 mcg to about 680 mcg, from about 640 mcg to about 680 mcg, from about 650 mcg to about 680 mcg, from about 660 mcg to about 680 mcg, from about 670 mcg to about 680 mcg, from about 680 mcg to about 900 mcg, from about 680 mcg to about 890 mcg, from about 680 mcg to about 880 mcg, from about 680 mcg to about 870 mcg, from about 680 mcg to about 860 mcg, from about 680 mcg to about 850 mcg, from about 680 mcg to about 840 mcg, from about 680 mcg to about 830 mcg, from about 680 mcg to about 820 mcg, from about 680 mcg to about 810 mcg, from about 680 mcg to about 800 mcg, from about 680 mcg to about 790 mcg, from about 680 mcg to about 780 mcg, from about 680 mcg to about 770 mcg, from about 680 mcg to about 760 mcg, from about 680 mcg to about 750 mcg, from about 680 mcg to about 740 mcg, from about 680 mcg to about 730 mcg, from about 680 mcg to about 720 mcg, from about 680 mcg to about 710 mcg, from about 680 mcg to about 700 mcg, or from about 680 mcg to about 690 mcg;

A preferred dosage range of from about 0.5 mcg (or μg) to about 10.0 mcg of vitamin B12, or a most preferred dosage range of from about 2.0 mcg to about 8.0 mcg of vitamin B12, including, but not limited to, from about 0.5 mcg to about 9.5 mcg, from about 0.5 mcg to about 9.0 mcg, from about 0.5 mcg to about 8.5 mcg, from about 0.5 mcg to about 8.0 mcg, from about 0.5 mcg to about 7.5 mcg, from about 0.5 mcg to about 7.0 mcg, from about 0.5 mcg to about 6.5 mcg, from about 0.5 mcg to about 6.0 mcg, from about 0.5 mcg to about 5.5 mcg, from about 0.5 mcg to about 5.0 mcg, from about 0.5 mcg to about 4.5 mcg, from about 0.5 mcg to about 4.0 mcg, from about 1.0 mcg to about 10.0 mcg, from about 1.0 mcg to about 9.5 mcg, from about 1.0 mcg to about 9.0 mcg, from about 1.0 mcg to about 8.5 mcg, from about 1.0 mcg to about 8.0 mcg, from about 1.0 mcg to about 7.5 mcg, from about 1.0 mcg to about 7.0 mcg, from about 1.0 mcg to about 6.5 mcg, from about 1.0 mcg to about 6.0 mcg, from about 1.0 mcg to about 5.5 mcg, from about 1.0 mcg to about 5.0 mcg, from about 1.0 mcg to about 4.5 mcg, from about 1.0 mcg to about 4.0 mcg, from about 1.5 mcg to about 10.0 mcg, from about 1.5 mcg to about 9.5 mcg, from about 1.5 mcg to about 9.0 mcg, from about 1.5 mcg to about 8.5 mcg, from about 1.5 mcg to about 8.0 mcg, from about 1.5 mcg to about 7.5 mcg, from about 1.5 mcg to about 7.0 mcg, from about 1.5 mcg to about 6.5 mcg, from about 1.5 mcg to about 6.0 mcg, from about 1.5 mcg to about 5.5 mcg, from about 1.5 mcg to about 5.0 mcg, from about 1.5 mcg to about 4.5 mcg, from about 1.5 mcg to about 4.0 mcg, from about 2.0 mcg to about 10 mcg, from about 2.0 mcg to about 9.5 mcg, from about 2.0 mcg to about 9.0 mcg, from about 2.0 mcg to about 8.5 mcg, from about 2.0 mcg to about 7.5 mcg, from about 2.0 mcg to about 7.0 mcg, from about 2.0 mcg to about 6.5 mcg, from about 2.0 mcg to about 6.0 mcg, from about 2.0 mcg to about 5.5 mcg, from about 2.0 mcg to about 5.0 mcg, from about 2.0 mcg to about 4.5 mcg, from about 2.0 mcg to about 4.0 mcg, from about 2.5 mcg to about 10.0 mcg, from about 2.5 mcg to about 9.5 mcg, from about 2.5 mcg to about 9.0 mcg, from about 2.5 mcg to about 8.5 mcg, from about 2.5 mcg to about 8.0 mcg, from about 2.5 mcg to about 7.5 mcg, from about 2.5 mcg to about 7.0 mcg, from about 2.5 mcg to about 6.5 mcg, from about 2.5 mcg to about 6.0 mcg, from about 2.5 mcg to about 5.5 mcg, from about 2.5 mcg to about 5.0 mcg, from about 2.5 mcg to about 4.5 mcg, from about 2.5 mcg to about 4.0 mcg, from about 3.0 mcg to about 10.0 mcg, from about 3.0 mcg to about 9.5 mcg, from about 3.0 mcg to about 9.0 mcg, from about 3.0 mcg to about 8.5 mcg, from about 3.0 mcg to about 8.0 mcg, from about 3.0 mcg to about 7.5 mcg, from about 3.0 mcg to about 7.0 mcg, from about 3.0 mcg to about 6.5 mcg, from about 3.0 mcg to about 6.0 mcg, from about 3.0 mcg to about 5.5 mcg, from about 5.0 mcg, from about 3.0 mcg to about 4.5 mcg, from about 3.0 to about 4.0 mcg, from about 4.0 mcg to about 10.0 mcg, from about 4.0 mcg to about 9.5 mcg, from about 4.0 mcg to about 9.0 mcg, from about 4.0 mcg to about 8.5 mcg, from about 4.0 mcg to about 8.0 mcg, from about 4.0 mcg to about 6.5 mcg, from about 4.0 mcg to about 6.0 mcg, from about 4.0 mcg to about 5.5 mcg, or from about 4.0 mcg to about 5.0 mcg;

In accordance with certain examples of the present disclosure, the synergistic dietary supplement formulations administered according to methods of the present disclosure may include a component to improve bioavailability or configured to improve bioavailability. In certain examples, the component to improve bioavailability or configured to improve bioavailability is selected from the group consisting of a food complex, whole food matrix, delayed or controlled release technology, multi-compartment capsules or capsule-in-capsule technology, phytosome or liposome technology, cyclodextrin or other encapsulation technologies.

In certain examples, the active ingredients of the synergistic dietary supplement formulations administered according to methods of the present disclosure may be modified to complex with phospholipids of either vegetable or synthetic origin. In specific examples, these complexes are prepared by adding the phospholipid to the natural compound extract which has been dissolved in a protic solvent under reflux and with stirring.

The terms “complexed” and “encapsulated with phospholipids,” as used herein, unless stated otherwise, alone or in combination with other terms, refer to standard complexation and encapsulation procedures understood by a person of ordinary skill. In a specific example of “complexing,” or “encapsulation with phospholipids,” 40 g berberine extract was dissolved in ethanol (800 ml) and the solution was refluxed. Sunflower phospholipids (60 g) were slowly added in portions, under reflux and with stirring. The resulting suspension was refluxed with stirring for 1 hour, then, while hot, concentrated under reduced pressure and finally dried in oven to leave a final product of 98 g composed of berberine extract complexed with phospholipids. This process may be repeated with varying rations of purified or enriched plant extracts with a ratio ranging from 10:1 phospholipid to extract, down to 1:1 phospholipid to extract.

The term “standardized” and “standardization,” as used herein, unless stated otherwise, alone or in combination with other terms, refer to processes known to those of ordinary skill in the art applied to active ingredients of the synergistic dietary supplement formulations to ensure that seasonal variation, or batch effects, or raw material sourcing, or other variations in the supply chain do not affect composition of the extracted materials, and that the ingredients maintain a specific ratio of active polyphenolic components.

In an example of standardization for grape seed extract, polyphenols are extracted from the seeds of Vitis vinifera using water. To compensate for seasonal or batch fluctuations in polyphenol levels, the extracts from multiple extract batches may be blended or combined following measurements to standardize the level and ratio of polyphenols. The extract is standardized to ensure 5-15% monomers (catechin+epicatechin), and >80% of the extract by mass was oligomeric proanthocyanidins.

In an example of standardization for passionflower, an extract from flower of Passifora incarnata is extracted using a water-ethanol mixture. To compensate for batch fluctuations or variations in raw materials, the extracts from multiple extract batches are blended or combined following measurements to ensure the extract contains >4% vitexin by weight.

In an example of standardization for berberine, an extract from Berberis aristate roots was obtained using a water-ethanol mixture. To increase solubility of the berberine, the extract is enriched to increase the concentration of berberine chloride to 60-98% by weight, but to ensure that some of the matrix remains. The extract is combined with other materials (lecithin, protein powder) to reduce aggregation. To compensation for batch variations, the extract may be combined or blended to ensure that the final product contains 25-40% berberine chloride by weight.

In certain examples, the elemental magnesium has been modified to produce a chelate with an amino acid such as glycine, to produce magnesium diglycinate. In other examples, a magnesium-counter ion compound, such as magnesium threonate, is used. In still other examples, magnesium oxide is used.

In certain examples, the elemental zinc has been modified to produce a chelate with an amino acid such as glycine, to produce zinc glycinate monohydrate.

In certain examples, the dietary supplement has been modified or configured to increase bioavailability through a reduction in particle size through micronization.

In certain examples, the dietary supplement further includes a component to extend the release kinetics. In other examples, the component to extend release kinetics is selected from the group consisting of a food complex, whole food matrix, delayed or controlled release technology. In certain examples, cellulose, or similar bioadhesive polymers, may be used to protect the dietary supplement from the stomach pH and extend release kinetics. In certain examples, waxy substances, including, but not limited to, Carnauba wax may be used to encapsulate the dietary supplement to extend release kinetics.

In certain examples, the synergistic dietary supplement formulation may include soluble or insoluble dietary fiber that may moderate or reduce the speed of glucose uptake following eating. Examples may include psyllium and methylcellulose.

Without being bound by theory, it is believed that active ingredients of the synergistic dietary supplement formulations administered according to methods of the present disclosure, including berberine, may increase glucagon-like peptide-1 levels.

Without being bound by theory, it is believed that active ingredients of the synergistic dietary supplement formulations administered according to methods of the present disclosure, including berberine, passionflower extract, grape seed extract, and/or magnesium, may reduce inflammatory markers including c-reactive protein and inflammatory cytokines.

Without being bound by theory, it is believed that active ingredients of the synergistic dietary supplement formulations administered according to methods of the present disclosure, including berberine, may increase the activity of Adenosine Mono-phosphate Kinase.

Without being bound by theory, it is believed that active ingredients of the synergistic dietary supplement formulations administered according to methods of the present disclosure, including grape seed extract and/or berberine, may moderate neurotransmitter levels such as γ-aminobutyric acid, serotonin, or dopamine.

Without being bound by theory, it is believed that active ingredients of the synergistic dietary supplement formulations administered according to methods of the present disclosure, including grape seed extract, procyanidins extracted from French maritime pine bark, or extracts from Phaseolus vulgaris, may reduce carbohydrate absorption by inhibiting α-amylase activity.

Without being bound by theory, it is believed that active ingredients of the synergistic dietary supplement formulations administered according to methods of the present disclosure, including grape seed extract, green tea extract, resveratrol, and/or quercetin, may reduce oxidative stress through direct scavenging of free radicals, changes in iNOS or eNOS or increased glutathione.

Without being bound by theory, it is believed that active ingredients of the synergistic dietary supplement formulations administered according to methods of the present disclosure, including magnesium and/or zinc, may alleviate nutritional deficiencies in the general population linked to insulin resistance.

Without being bound by theory, it is believed that active ingredients of the synergistic dietary supplement formulations administered according to methods of the present disclosure, including grape seed extract and/or berberine, may modulate intestinal dysbiosis and/or improve the intestinal microbiome.

The methods and systems described above may be further understood in connection with the following Examples. No limitation of the scope of the disclosure is intended by the illustration and description of certain examples of the disclosure. In addition, any alterations and/or modifications of the illustrated and/or described example(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

### Examples

An open-label clinical trial will be performed to determine the effect of a synergistic dietary supplement formulation administered according to methods of the present disclosure on mood, skin, energy, and food cravings.

Duration of the clinical trial will be between 60 and 90 days (2 and 3 months).

The total number of clinical trial participants is expected to be from 30 subjects to 70 subjects. The general inclusion criteria for subjects of the clinical trial include: acne or skin breakouts that a subject believes are linked to hormones (either perimenopause or menstrual cycle); breakouts or acne along a subject's jawline; variations in mood that a subject believes are linked to hormones (either perimenopause or menstrual cycle); food cravings; and changes in energy levels (sudden drops or crashes) that a subject believes are linked to hormones. The general exclusion criteria for subjects of the clinical trial include: pregnant subjects, breastfeeding subjects, and diabetic subjects.

The clinical study subjects will be split into two subgroups. The first subgroup will be made up of subjects aged 18-38 years old, constituting 40-60% of the study participants. The second subgroup will be made up of subjects aged 45-55 years old, constituting the remainder of the study participants.

Study participants will be administered an exemplary synergistic dietary supplement formulation including individual active ingredients within the maximum and minimum daily amounts listed in Table 1.

TABLE 1

| | Maximum | | Minimum | |
|---|---|---|---|---|
| Active Ingredient | Daily Dose | | Daily Dose | |
| Passion flower (Passiflora | 140 | mg | 30 | mg |
| incarnata) extract (aerial parts) | | | | |
| Grape (Vitis vinifera) extract (seed) | 280 | mg | 90 | mg |
| Berberis aristate (root) | 140 | mg | 40 | mg |
| Thiamin (as thiamine HCl) | 25 | mg | 2 | mg |
| Vitamin B6 (as pyridoxine HCl) | 25 | mg | 2 | mg |
| Folate (calcium L-5- | 800 | mcg DFE | 300 | mcg DFE |
| metyltetrahydrofolate) | | | | |
| Vitamin B12 (as cyanocobalamin) | 8 | mcg | 2 | mcg |
| Magnesium (as magnesium oxide | 40 | mg | 5 | mg |
| complexed with sunflower lecithin) | | | | |
| Zinc (as zinc glycinate | 30 | mg | 2 | mg |
| monohydrate) | | | | |

Data collected will include self-reported surveys of mood, energy, skin, and cravings; photos taken of subjects' faces in uniform lighting; and blood draws for biomarker data linked to metabolic or inflammatory state. Biomarkers associated with metabolic hormones include HbA1c and LDL cholesterol. Improvements for metabolic markers would constitute a statistically significant reduction (p>0.05 for a paired t-test) in HbA1c or LDL cholesterol. Biomarker data associated with inflammation include C-Reactive Protein (“CRP”). An improvement would constitute a statistically significant reduction in CRP levels (p<0.05 for a paired t-test).

It is expected that administration of a synergistic dietary supplement formulation to clinical trial participants will result in greater improvements in self-reported mood, skin, energy levels, and/or cravings than additive improvements in self-reported mood, skin, energy levels, and/or cravings from administration of individual active ingredients of the synergistic dietary supplement formulation. It is further expected that administration of a synergistic dietary supplement formulation to clinical trial participants will result in greater improvements in blood biomarkers linked with metabolic hormones or inflammation levels than additive improvements in blood biomarkers from administration of individual active ingredients of the synergistic dietary supplement formulation. Subpopulation analyses of outcomes will be performed based on age group, and whether the clinical trial participants are menstruating or experiencing perimenopause.

It is expected that because the dietary supplement formulation of the present disclosure is synergistic, intervention with only one or two of the active ingredients or components of the synergistic dietary supplement formulation of the present disclosure would not provide the benefits in subjective symptom improvement or measured metabolic markers that would be provided by intervention with the synergistic dietary supplement formulation. Further, it is expected that short term improvement in metabolic markers, for example, those metabolic markers measurable by a continuous glucose monitor, would not improve dramatically by intervention with any of the single active ingredients to the exclusion of intervention by any of the other single active ingredients. By contrast, it is believed that the synergy of the active ingredients of the dietary supplement formulation of the present disclosure would provide an unexpected and dramatic improvement in metabolic markers due to the combination of the active ingredients and components disclosed herein. It is expected that a statistically significant improvement in short-term metabolic improvement by an intervention with the combination of the active ingredients and components of the synergistic dietary supplement formulation of the present disclosure would be further realized in longer-term metabolic performance and significant improvement of subjective symptoms as compared with intervention by any of the active ingredients or components in isolation.

Clinical Trial Results

Abstract: Hormones are critical for human functioning. However, if hormones are imbalanced, the imbalance may lead to harmful outcomes. While hormones naturally fluctuate throughout the menstrual cycle, it is common for hormones to become imbalanced. As provided in the present disclosure, the dietary supplement formulation may help women better balance their hormones. The effectiveness of the dietary supplement formulation on perceived discomfort associate with hormone imbalance and on blood biomarkers related to metabolic imbalance was examined.

Conclusion: Participants in the clinical trial experienced significant improvements in skin health, mood balance, and sleep outcomes across the clinical trial. There was also a reduction in total and LDL cholesterol during the clinical trial. There was additionally a reduction in fasting insulin. The results of the clinical trial may suggest that the improvements in mood, skin, energy, sleep, and cravings were due to improvements in the underling metabolic rates of the clinical trial participants. Specifically, the improvements in mood, skin, energy, sleep, and cravings may be a result of promoting positive biomarker outcomes associated with reduced metabolic imbalance.

Purpose: The clinical trial had several overarching objectives. One objective of the clinical trial was to assess the efficacy of the dietary supplement formulations of the present disclosure in reducing perceived discomfort associated with hormone imbalance. Another objective of the clinical trial was to determine the effectiveness of the dietary supplement formulations of the present disclosure on blood biomarkers associated with metabolic imbalance. Yet another objective of the clinical trial was to examine changes in skin quality across the clinical trial by photos taken by the participants.

Subjects and Methods:

Participants. Forty-five participants enrolled in the clinical trial. The participants were recruited, and the clinical trial was conducted, by an independent third party organization. The participants had ages from 18 to 55 years old, and experienced moderate hormone imbalance discomfort. Specifically, participants had to report issues with their skin, mood states, cravings for food, energy levels, or weight management to be included in the clinical trial. Individuals who took medication for blood pressure, blood thinning, or diabetes were excluded from the clinical trial. Individuals were also excluded from the clinical trial if the individuals had known allergic reactions to the dietary supplement formulation components, were consistently exercising, or were on a ketogenic or vegan diet.

Methods. Participants received 120 capsules of the dietary supplement formulation (two jars, each containing 60 capsules) and were instructed to ingest two capsules daily. Participants were instructed to take the capsules in the morning with breakfast, and that if they forgot to take a capsule during breakfast, to ingest a capsule as soon as possible. Before starting to ingest the capsules (“Baseline”), participants took a baseline survey. The survey measured different skincare issues, mood states, food cravings, energy levels, and sleep outcomes. The survey was repeated on Day 7, Day 30, and Day 60. Participants also completed a biomarker analysis at Baseline and on Day 60. The biomarker analysis was performed using an at-home finger prick. The finger prick test required that participants fast overnight or for at least 12 hours to obtain a fasted level of metabolic hormones.

Results:

Quantitative Findings. Participants responded to surveys at Baseline and on Days 7, 30, and 60. These surveys specifically asked questions that aligned with the main purpose of the clinical trial. Repeated Measures Analysis of Variance (“RM ANOVAs”) were used to examine the difference over time in the key outcomes of interest. For perceived health outcomes, higher values indicated better perceived health, and lower values indicated worse health.

Table 2 below highlights the questions, the means, and the standard deviations at each time point, and the RM ANOVA result. The baseline measurement was taken before participants used the dietary supplement formulation of the present disclosure. For the Baseline, Day 7, Day 30, and Day 60 columns, the values are the mean and standard deviation, in that order.

TABLE 2
Mean Changes in Health Outcomes Across the Trial

| Symptom | Baseline | Day 7 | Day 30 | Day 60 | p-value |
|---|---|---|---|---|---|
| Overall Skin Quality | 3.81 | 4.08 | 4.51 | 4.81 | <.001* |
| | (0.97) | (1.01) | (0.99) | (1.27) | |
| Does your skin | 4.03 | 4.32 | 5.03 | 5.22 | <.001* |
| negatively impact | (1.19) | (1.38) | (1.38) | (1.29) | |
| your social life? | | | | | |
| Skin Smoothness | 3.87 | 4.00 | 4.57 | 4.84 | <.001* |
| | (0.89) | (0.78) | (0.80) | (1.14) | |
| Breakouts | 4.22 | 4.27 | 4.68 | 5.00 | <.001* |
| | (0.85) | (1.05) | (1.11) | (1.31) | |
| Mood Swings | 3.57 | 4.03 | 4.62 | 5.22 | <.001* |
| | (1.07) | (1.24) | (1.21) | (1.25) | |
| Anxiety | 3.08 | 3.65 | 4.19 | 4.57 | <.001* |
| | (1.21) | (1.51) | (1.33) | (1.32) | |
| Feeling down | 3.46 | 3.97 | 4.60 | 4.92 | <.001* |
| | (1.12) | (1.34) | (1.46) | (1.61) | |
| Sudden Feelings of | 4.41 | 5.14 | 5.57 | 5.76 | <.001* |
| Anger | (1.19) | (1.42) | (1.35) | (1.36) | |
| Strong Food Cravings | 3.51 | 4.16 | 4.65 | 4.92 | <.001* |
| | (1.15) | (1.32) | (1.53) | (1.52) | |
| Energy Levels | 2.65 | 3.60 | 4.00 | 4.22 | <.001* |
| | (1.11) | (1.40) | (1.43) | (1.51) | |
| Fatigue | 2.70 | 3.27 | 3.95 | 4.14 | <.001* |
| | (1.20) | (1.35) | (1.35) | (1.58) | |
| Needing to Snack | 3.81 | 4.54 | 4.87 | 5.08 | <.001* |
| All the Time | (1.39) | (1.48) | (1.58) | (1.61) | |
| Issues Falling Asleep | 3.65 | 4.43 | 4.78 | 4.73 | <.001* |
| | (1.55) | (1.61) | (1.32) | (1.45) | |
| Issues Staying Asleep | 3.73 | 4.27 | 4.43 | 4.81 | <.001* |
| | (1.73) | (1.68) | (1.41) | (1.60) | |
| Hot Flashes | 4.78 | 5.22 | 5.57 | 5.65 | .001* |
| | (1.72) | (1.73) | (1.48) | (1.60) | |
| Night Sweats | 4.35 | 5.00 | 5.41 | 5.57 | <.001* |
| | (1.70) | (1.84) | (1.64) | (1.61) | |
| Weight | 184.30 | 181.85 | 185.74 | 182.47 | .27 |
| | (55.45) | (55.21) | (55.70) | (52.38) | |

Note:
The values in Table 2 for Baseline, Day 7, Day 30, and Day 60 are the mean and standard deviation at the respective time point for the question in the left column in Table 2. The standard deviation is in parentheses. The statistical tests in Table 2 are RM ANOVAs. When sphericity was violated in the RM ANOVA, the Greenhouse-Geisser correction was used.
*indicates a statistically significant RM ANOVA.

Participants significantly improved on each measure taken in Table 2, outside of weight. This analysis indicates that over a 60-day period, participants experienced significant improvements in skin health, mood regulation, and sleep issues. To better understand the changes in the values throughout the clinical trial, the percentage of people who reported improvement at each time point over their baseline scores was calculated. The percentage of people who improved over baseline scores is highlighted in Table 3 below.

TABLE 3
Percentage of participants experiencing improvements
in symptoms compared to baseline.

| | Baseline - | Baseline - | Baseline - |
|---|---|---|---|
| | Day 7: % of | Day 30: % of | Day 60: % of |
| | Participants | Participants | Participants |
| | Improved | Improved | Improved |
| Symptom | (n = 43) | (n = 40) | (n = 37) |
| Overall Skin Quality | 46.5% | 55% | 73% |
| Does your skin | 32.6% | 65% | 67.6% |
| negatively impact | | | |
| your social life? | | | |
| Skin Smoothness | 30.2% | 55% | 73% |
| Breakouts | 18.6% | 35% | 54.1% |
| Mood Swings | 48.8% | 70% | 86.5% |
| Anxiety | 53.5% | 67.5% | 86.5% |
| Feeling down | 51.2% | 72.5% | 81.1% |
| Sudden Feelings of | 44.2% | 67.5% | 73% |
| Anger | | | |
| Strong Food Cravings | 53.5% | 60% | 75.7% |
| Energy Levels | 60.5% | 72.5% | 78.4% |
| Fatigue | 44.2% | 67.5% | 78.4% |
| Needing to Snack All the | 53.5% | 57.5% | 64.9% |
| Time | | | |
| Issues Falling Asleep | 44.2% | 62.5% | 59.5% |
| Issues Staying Asleep | 37.2% | 55% | 59.5% |
| Hot Flashes | 32.6% | 52.5% | 48.6% |
| Night Sweats | 44.2% | 57.5% | 64.9% |

Note:
The above values were calculated by evaluating the percentage of participants that improved above their Baseline value at each of the listed measurement times.

The data indicates that participants substantially improved the measured variables, especially on Day 60. 86.5% of participants improved their mood swings and anxiety on Day 60. Also, 78.4% of participants experienced an increase in energy levels and a decrease in the fatigue they experienced. 73% of participants noticed improvements in their skin at Day 60 compared to the Baseline measurement.

Overall, on average, most participants experienced significant symptom relief when using the dietary supplement formulations of the present disclosure during the two-month clinical trial. This finding supports the efficacy of the dietary supplement formulations of the present disclosure in helping to alleviate common hormone imbalance symptoms.

A purpose of the clinical trial was to examine the dietary supplement formulation's effectiveness on blood biomarkers associated with metabolic imbalance. The blood biomarker variables of interest included Insulin, hs-CRP, Hemoglobin A1C, Triglycerides, Cholesterol, HDL Cholesterol, LDL Cholesterol, and VLDL Cholesterol. Some values were undefined for testing reasons and were treated as missing data in this analysis. Also, some HDL cholester values were registered as <25 mg/dL. Because an RM-ANOVA needs a continuous variable, those values were re-coded to be 25 mg/dL. The means and standard deviations from those measurements are included in Table 4 below.

TABLE 4

| Test | Baseline | Day 60 | p-value |
|---|---|---|---|
| Insulin | 18.80 | 12.21 | 0.04* |
| | (24.77) | (10.49) | |
| hs-CRP (mg/L) | 2.94 | 2.55 | 0.53 |
| | (4.47) | (2.29) | |
| HbA1C (%) | 4.79 | 4.84 | 0.56 |
| | (0.77) | (0.76) | |
| Triglycerides | 152.82 | 143.30 | 0.42 |
| (mg/dL) | (77.94) | (97.82) | |
| Total Cholesterol | 215.13 | 171.10 | <0.001* |
| (mg/dL) | (46.13) | (36.50) | |
| LDL (mg/dL) | 132.95 | 106.10 | 0.006* |
| | (34.30) | (29.89) | |
| VLDL (mg/dL) | 31.65 | 29.77 | 0.45 |
| | (15.35) | (19.60) | |

Note:
Means and standard deviations in Table 4 were for participants who had complete data for the test that is listed. The test for fasting insulin was conducted as a one-tailed test because there was a strong a priori hypothesis that there would be a reduction in fasting insulin.

There were significant changes in total, and LDL cholesterol and in fasting insulin levels. These are all positive outcomes that suggest improvements in the participants' metabolic states. Although not statistically significant, there were reductions in hs-CRP, triglycerides, and VLDL cholesterol, and lower values of hs-CRP, triglycerides, and VLDL cholesterol are considered optimal.

While in the foregoing specification this invention has been described in relation to certain examples thereof, and many details have been put forth for the purpose of illustration, it will be apparent to those skilled in the art that the invention is susceptible to additional examples and that certain of the details described herein can be varied considerably without departing from the basic principles of the invention.

All references cited herein are incorporated by reference in their entireties. The present invention may be exemplified in other specific forms without departing from the spirit or essential attributes thereof and, accordingly, reference should be made to the appended claims, rather than to the foregoing specification, as indicating the scope of the invention.

The subject-matter of the disclosure may also relate, among others, to the following aspects:

A first aspect relates to a method of treating mood fluctuations, skin blemishes, low energy levels, and/or dietary cravings associated with hormonal fluctuations and/or menstruation in a female human, comprising: administering to the female human a dietary supplement formulation comprising a mixture comprising three or more components comprising berberine, grape seed extract, and passionflower extract; wherein the dietary supplement formulation is administered daily for at least four weeks; and wherein the three or more components act synergistically to treat mood fluctuations, skin blemishes, low energy levels, and/or dietary cravings.

A second aspect relates to the method of aspect 1, wherein the mixture comprises a total combined daily dose of: from about 30 milligrams to about 400 milligrams of berberine; from about 50 milligrams to about 400 milligrams of grape seed extract; and from about 10 milligrams to about 200 milligrams of passionflower extract;

A third aspect relates to the method of any one of aspects 1 and 2, wherein the dietary supplement formulation further comprises a total combined daily dose of one or more components selected from: from about 1 milligram to about 100 milligrams of magnesium; from about 1 milligram to about 60 milligrams of zinc; from about 1 milligram to about 30 milligrams of vitamin B1; from about 1 milligram to about 30 milligrams of vitamin B6; from about 150 micrograms to about 900 micrograms of dietary folate equivalents (“DFE”) of vitamin B9; and/or from about 0.5 micrograms to about 10 micrograms of vitamin B12.

A fourth aspect relates to the method of any one of the preceding aspects, wherein the dietary supplement formulation further comprises psyllium and/or methylcellulose.

A fifth aspect relates to the method of any one of the preceding aspects, wherein the dietary supplement formulation comprises: from about 40 milligrams to about 140 milligrams of berberine; from about 90 milligrams to about 280 milligrams of grape seed extract; and from about 30 milligrams to about 140 milligrams of passionflower extract.

A sixth aspect relates to the method of any one of the preceding aspects, wherein the dietary supplement formulation comprises: from about 70 milligrams to about 90 milligrams of berberine; from about 170 milligrams to about 190 milligrams of grape seed extract; and from about 70 milligrams to about 90 milligrams of passionflower extract.

A seventh aspect relates to the method of any one of the preceding aspects, wherein the dietary supplement formulation further comprises: from about 5 milligrams to about 40 milligrams of magnesium; from about 2 milligrams to about 30 milligrams of zinc; from about 2 milligrams to about 25 milligrams of vitamin B1; from about 2 milligrams to about 25 milligrams of vitamin B6; from about 300 micrograms to about 800 micrograms of DFE of vitamin B9; and/or from about 2 micrograms to about 8 micrograms of vitamin B12.

An eighth aspect relates to a method of improving level(s) of one or more blood biomarkers associated with metabolic hormones and/or inflammation levels in a female human, comprising: administering to the female human a dietary supplement formulation comprising three or more components comprising a total combined daily dose of: from about 30 milligrams to about 400 milligrams of berberine; from about 50 milligrams to about 400 milligrams of grape seed extract; and from about 10 milligrams to about 200 milligrams of passionflower extract; wherein the dietary supplement formulation is administered daily for at least four weeks; wherein the three or more components act synergistically to improve level(s) of one or more blood biomarkers; and wherein the one or more blood biomarkers are selected from the group consisting of HbA1c, LDL cholesterol, and CRP.

A ninth aspect relates to the method of aspect 8, wherein the dietary supplement formulation further comprises a total combined daily dose of one or more components selected from: from about 1 milligram to about 100 milligrams of magnesium; from about 1 milligram to about 60 milligrams of zinc; from about 1 milligrams to about 30 milligrams of vitamin B1; from about 1 milligram to about 30 milligrams of vitamin B6; from about 150 micrograms to about 900 micrograms of dietary folate equivalents (DFE) of vitamin B9; and/or from about 0.5 micrograms to about 10 micrograms of vitamin B12.

A tenth aspect relates to the method of any one of aspects 8 and 9, wherein the dietary supplement formulation further comprises psyllium and/or methylcellulose.

An eleventh aspect relates to the method of any one of aspects 8 to 10, wherein the dietary supplement formulation comprises: from about 40 milligrams to about 140 milligrams of berberine; from about 90 milligrams to about 280 milligrams of grape seed extract; and from about 30 milligrams to about 140 milligrams of passionflower extract.

A twelfth aspect relates to the method of any one of aspects 8 to 11, wherein the dietary supplement formulation comprises: from about 70 milligrams to about 90 milligrams of berberine; from about 170 milligrams to about 190 milligrams of grape seed extract; and from about 70 milligrams to about 90 milligrams of passionflower extract.

A thirteenth aspect relates to the method of any one of aspects 8 to 12, wherein the dietary supplement formulation further comprises: from about 5 milligrams to about 40 milligrams of magnesium; from about 2 milligrams to about 30 milligrams of zinc; from about 2 milligrams to about 25 milligrams of vitamin B1; from about 2 milligrams to about 25 milligrams of vitamin B6; from about 300 micrograms to about 800 micrograms of DFE of vitamin B9; and/or from about 2 micrograms to about 8 micrograms of vitamin B12.

A fourteenth aspect relates to a hormonal imbalance treatment system, comprising: a single dosage form mixture of three or more components comprising: from about 30 milligrams to about 400 milligrams of berberine that has been standardized, or complexed or encapsulated with phospholipids; from about 50 milligrams to about 400 milligrams of grape seed extract that has been standardized, or complexed or encapsulated with phospholipids; and from about 10 milligrams to about 200 milligrams of passionflower extract that has been standardized, or complexed or encapsulated with phospholipids; and wherein synergistic activity of the mixture when administered daily for at least four weeks to a human population causes on average in a female human: a decrease in mood fluctuations; a decrease in skin blemishes; an improvement in low energy levels; a reduction in dietary cravings; and/or an improvement in level(s) of one or more blood biomarkers selected from the group consisting of HbA1c, LDL cholesterol, and CRP.

A fifteenth aspect relates to the treatment system of aspect 14, wherein the mixture further comprises: from about 5 milligrams to about 40 milligrams of magnesium; from about 2 milligrams to about 30 milligrams of zinc; from about 2 milligrams to about 25 milligrams of vitamin B1; from about 2 milligrams to about 25 milligrams of vitamin B6; from about 300 micrograms to about 800 micrograms of DFE of vitamin B9; and/or from about 2 micrograms to about 8 micrograms of vitamin B12.

In addition to the features mentioned in each of the independent aspects enumerated above, some examples may show, alone or in combination, the optional features mentioned in the dependent aspects and/or as disclosed in the description above and shown in the figures.

What is claimed is:

1. A method of treating mood fluctuations, skin blemishes, low energy levels, and/or dietary cravings associated with hormonal fluctuations and/or menstruation in a female human, comprising:
administering to the female human a dietary supplement formulation comprising three or more components comprising a total combined daily dose of:
from about 30 milligrams to about 400 milligrams of berberine;
from about 50 milligrams to about 400 milligrams of grape seed extract; and
from about 10 milligrams to about 200 milligrams of passionflower extract;
wherein the dietary supplement formulation is administered daily for at least four weeks; and
wherein the three or more components act synergistically to treat mood fluctuations, skin blemishes, low energy levels, and/or dietary cravings.

2. The method of claim 1, wherein the dietary supplement formulation further comprises a total combined daily dose of one or more components selected from:
from about 1 milligram to about 100 milligrams of magnesium;
from about 1 milligram to about 60 milligrams of zinc;
from about 1 milligram to about 30 milligrams of vitamin B1;
from about 1 milligram to about 30 milligrams of vitamin B6;
from about 150 micrograms to about 900 micrograms of dietary folate equivalents (“DFE”) of vitamin B9; and/or
from about 0.5 micrograms to about 10 micrograms of vitamin B12.

3. The method of claim 1, wherein the dietary supplement formulation further comprises psyllium and/or methylcellulose.

4. The method of claim 1, wherein the dietary supplement formulation comprises:
from about 40 milligrams to about 140 milligrams of berberine;
from about 90 milligrams to about 280 milligrams of grape seed extract; and
from about 30 milligrams to about 140 milligrams of passionflower extract.

5. The method of claim 1, wherein the dietary supplement formulation comprises:
from about 70 milligrams to about 90 milligrams of berberine;
from about 170 milligrams to about 190 milligrams of grape seed extract; and
from about 70 milligrams to about 90 milligrams of passionflower extract.

6. The method of claim 1, wherein the dietary supplement formulation further comprises:
from about 5 milligrams to about 40 milligrams of magnesium;
from about 2 milligrams to about 30 milligrams of zinc;
from about 2 milligrams to about 25 milligrams of vitamin B1;
from about 2 milligrams to about 25 milligrams of vitamin B6;
from about 300 micrograms to about 800 micrograms of DFE of vitamin B9; and/or
from about 2 micrograms to about 8 micrograms of vitamin B12.

7. A method of improving level(s) of one or more blood biomarkers associated with metabolic hormones and/or inflammation levels in a female human, comprising:
administering to the female human a dietary supplement formulation comprising three or more components comprising a total combined daily dose of:
from about 30 milligrams to about 400 milligrams of berberine;
from about 50 milligrams to about 400 milligrams of grape seed extract; and
from about 10 milligrams to about 200 milligrams of passionflower extract;
wherein the dietary supplement formulation is administered daily for at least four weeks;
wherein the three or more components act synergistically to improve level(s) of one or more blood biomarkers; and
wherein the one or more blood biomarkers are selected from the group consisting of HbA1c, LDL cholesterol, and CRP.

8. The method of claim 7, wherein the dietary supplement formulation further comprises a total combined daily dose of one or more components selected from:
from about 1 milligram to about 100 milligrams of magnesium;
from about 1 milligram to about 60 milligrams of zinc;
from about 1 milligram to about 30 milligrams of vitamin B1;
from about 1 milligram to about 30 milligrams of vitamin B6;
from about 150 micrograms to about 900 micrograms of dietary folate equivalents (“DFE”) of vitamin B9; and/or
from about 0.5 micrograms to about 10 micrograms of vitamin B12.

9. The method of claim 8, wherein the dietary supplement formulation further comprises psyllium and/or methylcellulose.

10. The method of claim 8, wherein the dietary supplement formulation comprises:
from about 40 milligrams to about 140 milligrams of berberine;
from about 90 milligrams to about 280 milligrams of grape seed extract; and
from about 30 milligrams to about 140 milligrams of passionflower extract.

11. The method of claim 8, wherein the dietary supplement formulation comprises:
from about 70 milligrams to about 90 milligrams of berberine;
from about 170 milligrams to about 190 milligrams of grape seed extract; and
from about 70 milligrams to about 90 milligrams of passionflower extract.

12. The method of claim 8, wherein the dietary supplement formulation further comprises:
from about 5 milligrams to about 40 milligrams of magnesium;
from about 2 milligrams to about 30 milligrams of zinc;
from about 2 milligrams to about 25 milligrams of vitamin B1;
from about 2 milligrams to about 25 milligrams of vitamin B6;
from about 300 micrograms to about 800 micrograms of DFE of vitamin B9; and/or
from about 2 micrograms to about 8 micrograms of vitamin B12.

13. A hormonal imbalance treatment system, comprising:
a single dosage form mixture of three or more components comprising:
from about 30 milligrams to about 400 milligrams of berberine that has been standardized, or complexed or encapsulated with phospholipids;
from about 50 milligrams to about 400 milligrams of grape seed extract that has been standardized, or complexed or encapsulated with phospholipids; and
from about 10 milligrams to about 200 milligrams of passionflower extract that has been standardized, or complexed or encapsulated with phospholipids; and
wherein synergistic activity of the mixture when administered daily for at least four weeks to a human population causes on average in a female human:
a decrease in mood fluctuations;
a decrease in skin blemishes;
an improvement in low energy levels;
a reduction in dietary cravings; and/or
an improvement in level(s) of one or more blood biomarkers selected from the group consisting of HbA1c, LDL cholesterol, and CRP.

14. The treatment system of claim 13, wherein the mixture further comprises:
from about 5 milligrams to about 40 milligrams of magnesium;
from about 2 milligrams to about 30 milligrams of zinc;
from about 2 milligrams to about 25 milligrams of vitamin B1;
from about 2 milligrams to about 25 milligrams of vitamin B6;
from about 300 micrograms to about 800 micrograms of DFE of vitamin B9; and/or
from about 2 micrograms to about 8 micrograms of vitamin B12.

15. A method of treating mood fluctuations, skin blemishes, low energy levels, and/or dietary cravings associated with hormonal fluctuations and/or menstruation in a human, comprising:
administering to the human a dietary supplement formulation comprising a mixture comprising three or more components comprising berberine, grape seed extract, and passionflower extract;
wherein the dietary supplement formulation is administered daily for at least four weeks; and
wherein the three or more components act synergistically to treat mood fluctuations, skin blemishes, low energy levels, and/or dietary cravings.

16. The method of claim 15, wherein the dietary supplement formulation comprises a mixture of a total combined daily dose of:
from about 30 milligrams to about 400 milligrams of berberine;
from about 50 milligrams to about 400 milligrams of grape seed extract; and
from about 10 milligrams to about 200 milligrams of passionflower extract.

17. The method of claim 15, wherein the dietary supplement formulation further comprises a total combined daily dose of one or more components selected from:
from about 1 milligram to about 100 milligrams of magnesium;
from about 1 milligram to about 60 milligrams of zinc;
from about 1 milligram to about 30 milligrams of vitamin B1;
from about 1 milligram to about 30 milligrams of vitamin B6;
from about 150 micrograms to about 900 micrograms of dietary folate equivalents (“DFE”) of vitamin B9; and/or
from about 0.5 micrograms to about 10 micrograms of vitamin B12.

18. The method of claim 15, wherein the dietary supplement formulation further comprises psyllium and/or methylcellulose.

19. The method of claim 15, wherein the dietary supplement formulation comprises a mixture of a total combined daily dose of:
from about 40 milligrams to about 140 milligrams of berberine;
from about 90 milligrams to about 280 milligrams of grape seed extract; and
from about 30 milligrams to about 140 milligrams of passionflower extract.

20. The method of claim 15, wherein the dietary supplement formulation comprises a mixture of a total combined daily dose of:
from about 70 milligrams to about 90 milligrams of berberine;
from about 170 milligrams to about 190 milligrams of grape seed extract; and
from about 70 milligrams to about 90 milligrams of passionflower extract.

21. The method of claim 15, wherein the dietary supplement formulation further comprises:
from about 5 milligrams to about 40 milligrams of magnesium;
from about 2 milligrams to about 30 milligrams of zinc;
from about 2 milligrams to about 25 milligrams of vitamin B1;
from about 2 milligrams to about 25 milligrams of vitamin B6;
from about 300 micrograms to about 800 micrograms of DFE of vitamin B9; and/or
from about 2 micrograms to about 8 micrograms of vitamin B12.

22. The method of claim 1, wherein the dietary supplement formulation is administered daily for at least 60 days.

23. The method of claim 7, wherein the dietary supplement formulation is administered daily for at least 60 days.

24. The treatment system of claim 13, wherein synergistic activity of the mixture when administered daily for at least 60 days to a human population causes on average in a female human:
the decrease in mood fluctuations;
the decrease in skin blemishes;
the improvement in low energy levels;
the reduction in dietary cravings; and/or
the improvement in level(s) of one or more blood biomarkers selected from the group consisting of HbA1c, LDL cholesterol, and CRP.

25. The method of claim 15, wherein the dietary supplement formulation is administered for at least 60 days.
